(19) United States
(12) Patent Application Publication
(10) Pub. No.: US 2023/0388817 A1
(43) Pub. Date: Nov. 30, 2023

(54) ACTIVATING INTELLIGENT WIRELESS COMMUNCIATION DEVICE REPORTING IN A WIRELESS NETWORK

(71) Applicant: Telefonaktiebolaget LM Ericsson (publ), Stockholm (SE)

(72) Inventors: Henrik Rydén, Stockholm (SE); Luca Lunardi, Genoa (IT); Angelo Centonza, Granada (ES); Pradeepa Ramachandra, Linköping (SE)

(21) Appl. No.: 18/032,370

(22) PCT Filed: Oct. 21, 2021
(86) PCT No.: PCT/EP2021/079263

§ 371 Date: Apr. 18, 2023

Related U.S. Application Data
(60) Provisional application No. 63/094,698, filed on Oct. 21, 2020.

(51) Int. Cl. H04W 24/02; H04L 41/16

(52) U.S. Cl. CPC H04W 24/02; H04L 41/16

(57) ABSTRACT

Systems and methods for activating intelligent wireless communication device reporting in a wireless network are disclosed. Embodiments of a method performed by a wireless communication device for machine-learned optimization of wireless networks is proposed. In one embodiment, the method includes sending, to a network node, information that indicates one or more capabilities of the wireless communication device for reporting of predicted values that are predicted by the wireless communication device using one or more machine learning capabilities of the wireless communication device. The method further includes receiving, from the network node, a request. The request includes (a) a request to start reporting predicted values, (b) a request to start training a machine learning model for generating predicted values, or (c) both (a) and (b). The method further includes performing one or more actions in response to receiving the request.

### TECHNICAL FIELD

The present disclosure relates to machine-learning or artificial intelligence within the context of a wireless network and, more specifically, to activating intelligent wireless communication device reporting in a wireless network.

### BACKGROUND

The current Fifth Generation (5G) Radio Access Network (RAN) architecture, referred to as the Next Generation RAN (NG-RAN) architecture, is depicted and described in Third Generation Partnership Project (3GPP) Technical Specification (TS) 38.401 (see, e.g., v16.3.0). In particular, FIG. 1 illustrates the overall NG-RAN architecture. Section 6.1.1 of 3GPP TS 38.401 v16.3.0 describes the NG-RAN architecture as follows. The NG-RAN consists of a set of New Radio base stations (gNBs) connected to the 5G Core (5GC) through the NG interface. A gNB can support Frequency Division Duplexing (FDD) mode, Time Division Duplexing (TDD) mode, or dual mode operation. gNBs can be interconnected through the Xn interface. A gNB may consist of a gNB Centralized Unit (gNB-CU) and one or more gNB Distributed Units (gNB-DUs). A gNB-CU and a gNB-DU are connected via F1 logical interface. One gNB-DU is connected to only one gNB-CU. For resiliency, a gNB-DU may be connected to multiple gNB-CUs by appropriate implementation. NG, Xn, and F1 are logical interfaces. The NG-RAN is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

A gNB may also be connected to a Long Term Evolution (LTE) evolved Node B (eNB) via the X2 interface. Another architectural option is that where an LTE eNB connected to the Evolved Packet Core (EPC) network is connected over the X2 interface with a so called nr-gNB. The latter is a gNB not connected directly to a core network (CN) and connected via X2 to an eNB for the sole purpose of performing dual connectivity.

The architecture in FIG. 1 can be expanded by spitting the gNB-CU into two entities, namely, one gNB-CU User Plane (gNB-CU-UP), which serves the user plane and hosts the Packet Detection Control Protocol (PDCP) protocol and one gNB-CU Control Plane (gNB-CU-CP), which serves the control plane and hosts the PDCP and Radio Resource Control (RRC) protocol. For completeness, it should be said that a gNB-DU hosts the Radio Link Control (RLC), Medium Access Control (MAC), and Physical layer (PHY) protocols.

It is important to fully utilize the potential of machine learning (ML) for wireless networks such as the NG-RAN of a 5GS, for example by extracting more data from all nodes in the network. One problem in applying ML for wireless networks is the variable data transfer cost depending on wired or over-the-air transmission. Enabling Artificial Intelligence (AI) or ML by extending the device reporting by including different types of information, from radio to physical measurements, would lead to increased signaling. The trade-off between increased data signaling versus enabling improved intelligence at the network is a challenging problem. FIG. 2 shows how only a subset of the available data at the device is sent to the network, where today the intelligence is built. FIG. 2 also shows how currently the intelligence is at the network side, while the devices are mainly considered as a data source. Note that there is a high cost associated to the data transfer from the device (over-the-air).

Another alternative is to explore the use of potential augmentation information provided by an AI-model at the device using so-called “intelligent devices”. FIG. 3 shows an example of how multiple data sources can be used to create intelligent augmentation data at the device.

The UE can have machine learning models able to predict a certain quantity. The model could for example be:
Downloaded to the device from the network. A method to configure a user device with an ML model has been proposed. By signaling a model to the device, it is possible to reduce over the air signaling for use cases where the model input is located at the device side.
The device could also have learned the intelligence using historical measurements, without any network downloaded model. The model could also have been downloaded to the device using over-the-top signaling

In regard to the use of intelligent networks, the use cases can comprise:
Traffic prediction: In delay critical applications, it is important to not lose uplink synchronization just before or during arrival of data, as the device otherwise has to synchronize the uplink prior to uplink transmission which increases the delay. One solution is to force the device to perform synchronization if no uplink transmission has taken place within a certain time window, but such a solution might lead to a large increase of signaling and interference as the uplink synchronization might not be needed. One could instead use prediction of data arrival to find out when synchronization is needed and also to make sure that the synchronization is completed before transmission is needed. The historical traffic experienced by one device can be used to train a model in said device that predicts when synchronization is needed or in general when uplink resources are needed.
Mobility prediction: Since one device typically moves within the similar trajectories each day, the device can instead of measuring signal strengths of neighboring cells, use its geo-location as one method to predict the signal strength of a particular reference signal. That can then be used to trigger different events for example a handover decision.
Secondary carrier prediction: In order to detect a radio node on another frequency using target carrier prediction, it requires the device to measure only on its source carrier. Using target carrier prediction with source carrier measurements, the device does not need to perform inter-frequency measurements, leading to energy savings at the device.

Signal quality prediction is of particular interest. Based on received User Equipment (UE) data from measurement reports, the network can learn, for example, what sequence of signal quality measurements (e.g. Reference Signal Received Power (RSRP)) that result in a large signal quality drop (e.g. turning around the corners in FIG. 4), for example, by dividing periodically reported RSRP data into a training window and a prediction window as also illustrated in FIG. 4.

In the example in FIG. 4, two UEs are turning around the same corner according to the location plot. The UE represented by the solid line first turns around the corner and experiences a large signal quality drop. Then the idea is to mitigate the drop of a second UE, which is represented by the dashed line, by using learning from the first UEs experience. FIG. 4 also shows how they are having similar measured RSRP characteristics. The learning can be done by feeding RSRP at times t₁, . . . , tₙ into a machine learning model (e.g. Neural network), and then learning the RSRP at times tₙ₊₁, tₙ₂. After the model is trained, the network can download the model to the UE, and the UE can then predict future signal quality values. The signal quality prediction can then be used for a number of Radio Resource Management (RRM) features such as:
Initiate inter-frequency handover,
Set handover/reselection parameters,
Change UE scheduler priority, for example schedule UE when the expected signal quality is good, and/or
Link adaptation, note that there is a time-delay from sending a channel quality indicator (CQI) value until it is used for LA.

### SUMMARY

Systems and methods for activating intelligent wireless communication device reporting in a wireless network are disclosed. Embodiments of a method performed by a wireless communication device for machine-learned optimization of wireless networks is proposed. In one embodiment, the method includes sending, to a network node, information that indicates one or more capabilities of the wireless communication device for reporting of predicted values that are predicted by the wireless communication device using one or more machine learning capabilities of the wireless communication device. The method further includes receiving, from the network node, a request. The request includes (a) a request to start reporting predicted values, (b) a request to start training a machine learning model for generating predicted values, or (c) both (a) and (b). The method further includes performing one or more actions in response to receiving the request. In this manner, network operation may be improved by supporting intelligent reporting.

In one embodiment, performing the one or more actions includes generating one or more reports comprising one or more predicted values based on the machine learning model sending the one or more reports to the network node. In one embodiment, performing the one or more actions further comprises training the machine learning model for generating the predicted values. In one embodiment, the one or more reports further comprise information that indicates an accuracy or confidence level of the one or more predicted values.

In one embodiment, generating and sending the one or more reports is activated when a triggering criterion is satisfied. In one embodiment, the triggering criterion is a required accuracy level for the one or more predicted values. In one embodiment, the triggering criterion is a required confidence level for the one or more predicted values. In one embodiment, the triggering criterion is a time-based triggering criterion. In one embodiment, the triggering criterion is a prediction performance-based triggering criterion. In one embodiment, the triggering criterion is based on: availability of network capabilities at the network node; subscription to one or more services at the network node; configuration at the wireless communication device for (a) Guaranteed Flow Bit Rate (GFBR) for Upload and Download, (b) Maximum Packet Loss Rate for Upload and Download, (c) reporting of Quality of Experience (QoE) measurements for at least one application, or (d) any two or more of (a)-(c); detection of a change of Quality of Service (QoS) parameters associated with the wireless communication device; the wireless communication device being served by a certain slice; the wireless communication device being located within a geographic area; the wireless communication device having a specific Service Profile Identifier (SPID); or a mobility pattern of the wireless communication device.

In one embodiment, the request comprises a request to start reporting predicted values at a particular time(s) or during a particular time window(s). In some embodiments, the predicted values comprise predicted Radio Resource management (RRM) related values. In one embodiment, the predicted values comprise predicted beam related values. In one embodiment, the predicted values comprise predicted values for future traffic needs of the wireless communication device.

In one embodiment, the predicted values comprise predicted measurement values for (a) one or more frequencies, (b) traffic steering, (c) serving cell selection, (d) QoS prediction, (e) RRM, or (f) any two or more of (a)-(e).

In one embodiment, the information that indicates one or more capabilities of the wireless communication device for reporting of predicted values further comprises a performance metric indicative of an accuracy of the wireless communication device for performance of the one or more capabilities

In one embodiment, the information that indicates the one or more capabilities of the wireless communication device for reporting of predicted values comprises physical characteristic data for the wireless communication device descriptive of: (a) battery power, (b) available memory, (c) computational capacity, (d) sensor capabilities, (e) parameters descriptive of a physical environment of the wireless communication device, (f) acceleration or velocity of the wireless communication device, (g) nearby network infrastructure, or (h) any two or more of (a)-(g).

In one embodiment, prior to sending the information that indicates the one or more capabilities, the method further includes receiving a request from the network node for the one or more capabilities of the wireless communication device for reporting of predicted values. Sending the information that indicates the one or more capabilities of the wireless communication device for reporting of predicted values comprises sending the information that indicates the one or more capabilities of the wireless communication device for reporting of predicted values responsive to receiving the request from the network node for the one or more capabilities of the wireless communication device for reporting of predicted values.

In one embodiment, performing the one or more actions in response to receiving the request comprises activating one or more procedures that replace measurements with predicted values.

In one embodiment, performing the one or more actions comprises, after transitioning from a connected state to an inactive state and subsequently transitioning back to the connected state in association to a second network node, providing data resulting from performing the one or more actions to the second network node.

Corresponding embodiments of a wireless communication device are disclosed. In one embodiment, a wireless communication device is adapted to send, to a network node, information that indicates one or more capabilities of the wireless communication device for reporting of predicted values that are predicted by the wireless communication device using one or more machine learning capabilities of the wireless communication device. The wireless communication device is adapted to receive, from the network node, a request, the request comprising: (a) a request to start reporting predicted values, (b) a request to start training a machine learning model for generating predicted values, or (c) both (a) and (b). The wireless communication device is adapted to perform one or more actions in response to receiving the request.

In one embodiment, a wireless communication device includes one or more transmitters, one or more receivers, and processing circuitry associated with the one or more transmitters and the one or more receivers. The processing circuitry is configured to cause the wireless communication device to send, to a network node, information that indicates one or more capabilities of the wireless communication device for reporting of predicted values that are predicted by the wireless communication device using one or more machine learning capabilities of the wireless communication device. The processing circuitry is further configured to cause the wireless communication device to receive, from the network node, a request, the request comprising: (a) a request to start reporting predicted values, (b) a request to start training a machine learning model for generating predicted values, or (c) both (a) and (b). The processing circuitry is further configured to cause the wireless communication device to perform one or more actions in response to receiving the request.

In some embodiments, a method performed by a network node for machine-learned optimization of wireless networks is proposed. The method includes receiving, from a plurality of wireless communication devices, information that indicates one or more capabilities of the plurality of wireless communication devices for reporting of predicted values. The method includes either or both of: (a) determining one or more wireless communication devices from which to request reporting of predicted values from the plurality of wireless communication devices based on the received information and (b) determining one or more reports to request from one or more wireless communication devices from among the plurality of wireless communication devices based on the received information. The method includes sending, to the one or more wireless communication devices, one or more messages related to activation of intelligent reporting. The one or more messages include (a) a request to start reporting predicted values, (b) a request to start training a machine learning model for generating predicted values, or (c) both (a) and (b).

Corresponding embodiments of a network node are also disclosed.

In another embodiment, a method performed by a network node includes sending, to a supervising network node, data indicative of a request to configure one or more wireless communication devices for reporting of predicted values. The method further includes responsive to sending the data indicative of the request, receiving, from the supervising network node, predicted values from the one or more wireless communication devices. The method further includes performing one or more actions based at least in part on the predicted values from the one or more wireless communication devices.

In one embodiment, sending the data indicative of the request to configure the one or more wireless communication devices comprises sending, to the supervising network node, data indicative of a request to configure one or more wireless communication devices for reporting of predicted values from the one or more wireless communication devices for beam level coverage for one or more of served beams or neighbor cell beams.

In one embodiment, performing the one or more actions comprises (a) adjusting a shape of one or more beams, (b) extending coverage of one or more beams, (c) reducing coverage of one or more beams, (d) reducing a number of beams for a geographic area, or (e) two or more of any of (a)-(d).

In one embodiment, the network node comprises a New Radio (NR) base station (gNB) Distributed Unit (DU), and the supervising node comprises a gNB Central Unit (CU).

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an example of the overall Next Generation (NG)-Random Access Network (RAN) architecture from Section 6.1.1 of Third Generation Partnership Project (3GPP) Technical Specification (TS) 38.401;

FIG. 2 illustrates an example data flow diagram between Wireless Communication Device (WCD) data sources, the WCD, and the network;

FIG. 3 illustrates one example of multiple data sources received at the WCD being used to create intelligent augmentation data at the device;

FIG. 4 illustrates an example of signal quality reduction in response to turning a corner, and also illustrates an example of dividing a periodic reported Reference Signal Received Power (RSRP) data into a training window and a prediction window;

FIG. 5 illustrates one example of a cellular communications system in which embodiments of the present disclosure may be implemented;

FIG. 6 is a flow chart that illustrates the operation of a network node or a network node that implements functionality of a component of a base station in accordance with an embodiment of the present disclosure;

FIG. 7 is a flow chart that illustrates the operation of a wireless communication device in accordance with an embodiment of the present disclosure;

FIG. 8 illustrates an example of triggering reporting of predicted values based on RAN paging according to some embodiments of the present disclosure;

FIG. 9 illustrates an example of triggering reporting of predicted values based on re-establishment to a cell other than one towards which an original establishment was attempted according to some embodiments of the present disclosure;

FIG. 10 illustrates an example wireless communication device providing a predicted beam value to a network node according to some embodiments of the present disclosure;

FIG. 11 is a schematic block diagram of a network node according to some embodiments of the present disclosure;

FIG. 12 is a schematic block diagram that illustrates a virtualized embodiment of the network node according to some embodiments of the present disclosure;

FIG. 13 is a schematic block diagram of the network node according to some other embodiments of the present disclosure;

FIG. 14 is a schematic block diagram of a wireless communication device according to some embodiments of the present disclosure;

FIG. 15 is a schematic block diagram of the wireless communication device according to some other embodiments of the present disclosure;

FIG. 16 is a flow chart that illustrates the operation of a supervised network node for requesting reporting from a supervised node according to some embodiments of the present disclosure;

FIG. 17 illustrates example of utilization of multiple data sources for creation of intelligent augmentation data at the WCD and/or at RAN nodes according to some embodiments of the present disclosure;

FIG. 18 illustrates an example in which a target network node provides reward information on WCD performance after handover procedure is completed according to some embodiments of the present disclosure;

FIG. 19 is a data flow diagram for signaling augmented information between a WCD, source node, and target node according to some embodiments of the present disclosure;

FIG. 20 illustrates activation or deactivation of a capacity cell triggered by a gNB that provides basic coverage according to some embodiments of the present disclosure; and

FIG. 21 illustrates an example of Quality of Service (QoS) and Service Level Agreement (SLA) fulfilment prediction based on enrichment and augmented information according to some embodiments of the present disclosure.

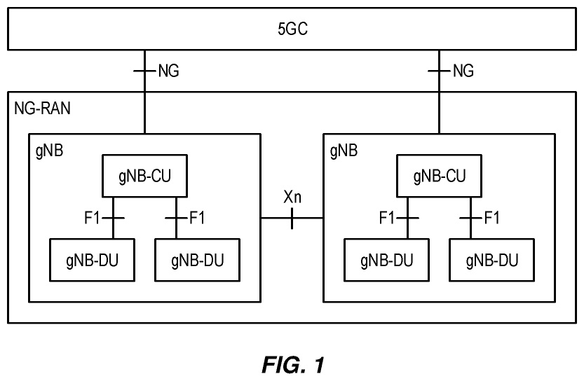

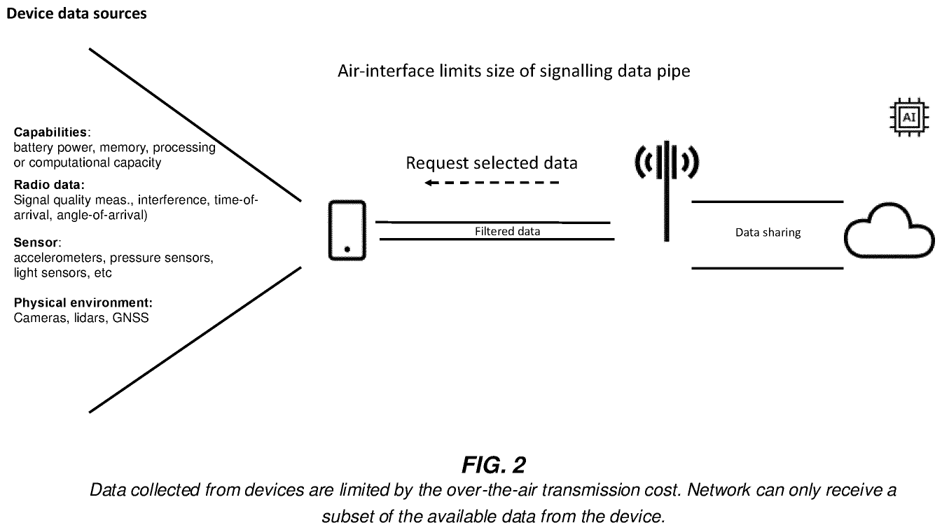

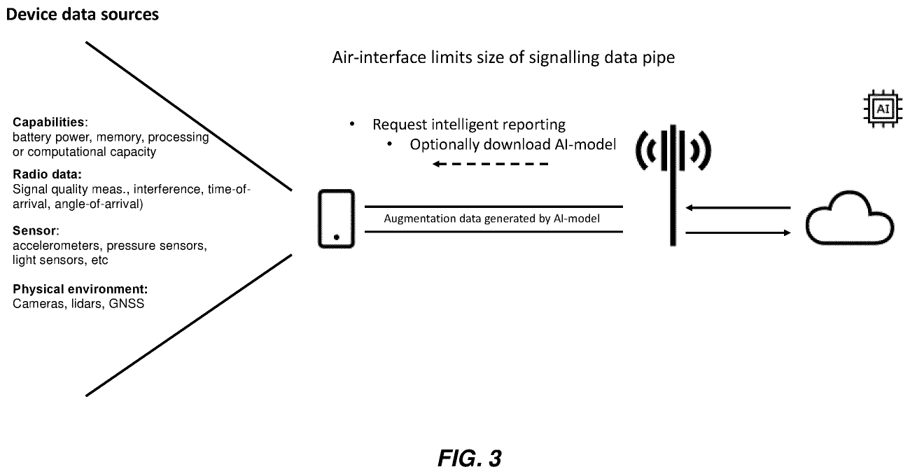

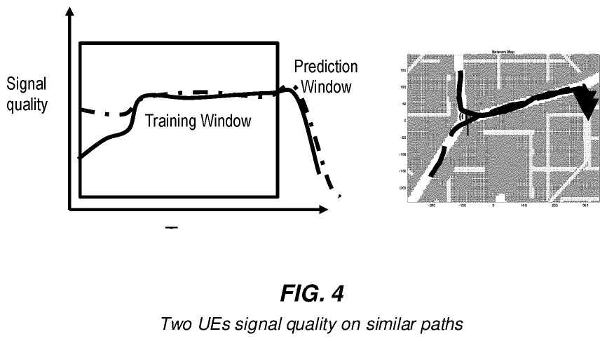

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing a Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Intelligent RRM Reporting: As used herein, “intelligent RRM reporting” is RRM reporting by a wireless communication device that is based on a machine learning model or artificial intelligence at the wireless communication device. Similarly, as used herein, an “intelligent RRM report” is a RRM report generated and sent by a wireless communication device to convey RRM related information that is based on a machine learning model or artificial intelligence at the wireless communication device.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). It is important to fully utilize the potentials in machine learning for wireless networks, for example by extracting more data from all nodes in the network. One method is to extend UE reporting by including different types of information, from radio to physical measurements. This would however lead to increased signaling. With the densification of radio networks, utilization of higher chunks of spectrum, and higher complexity of the network, it is important to leverage intelligence in all aspects of the network with minimal network impact. One method is to move some intelligence to the UE, by downloading such intelligence to the device. Methods to receive knowledge on whether the device is capable or configured to use machine learning (ML) models/algorithms has been proposed. Such method includes receiving from the device a message indicating whether it is either capable or configured to use (or it is using) machine learning models and algorithms for its operation. However, the existing solutions do not cover aspects on selecting and activating/deactivating the use of the ML-models for intelligent reporting. It is important to keep the signaling overhead to a minimum by making sure to only provide e.g. predicted signal quality information when it is needed at the network.

Certain aspects of the present disclosure and their embodiments may provide solutions to the aforementioned or other challenges. Embodiments of the present disclosure provide a framework for selecting and activating one or more intelligent reports from UEs, e.g., based on base station information and UE capabilities. In one embodiment, the intelligent report comprises a value estimated by a machine-learning algorithm such as, for example, a predicted future signal quality value or a value associated to one or more reference signals. In one embodiment, the intelligent report is used to configure one or more Radio Resource Management (RRM) related parameters.

Certain embodiments may provide one or more of the following technical advantage(s). Embodiments disclosed herein may improve RRM operation by leveraging improved capabilities from UEs supporting intelligent RRM reporting, by activating such reporting. The UE has more information (data) regarding its experienced radio environment and also of its surroundings using any type of available information (e.g., camera, Light Detection and Ranging (LIDAR), Global Naviation Satellite System (GNSS), Inertial Measurement Unit (IMU)). The amount of data available at the UE leads to improved machine learning models.

Embodiments disclosed herein may:
Provide efficient activation of intelligent RRM reporting. For example, activating intelligent reporting based on:
   Performance degradation (e.g. more #radio-link failures),
   network information (e.g. load), only activate intelligent methods when the network likely experience complex situations
      UE information,
   historical information
   Requesting report for only the time-instances when a UE report is useful, where the time-instances can be based on network scheduler or UE service type
Provide selecting which UEs to use intelligent reporting based on received capabilities from one or more UEs
Provide triggering of intelligent reporting when it fulfills a certain accuracy requirement, which leads to better performance since the report is only sent when useful. The network can configure the accuracy requirement based on the RRM operation.
Ensure prioritization of the intelligent reporting process at the UE by providing the UE with priority levels for the reporting process so that lower priority processes can, if needed, be deferred or interrupted in favor of higher priority processes.

Embodiments disclosed herein also list potential new intelligent reports from UEs, which enable better RRM. For example, signaling a future signal quality value as a probability density function.

Note that while many of the embodiments described herein focus on the example of intelligent RRM reporting, the present disclosure is not limited thereto.

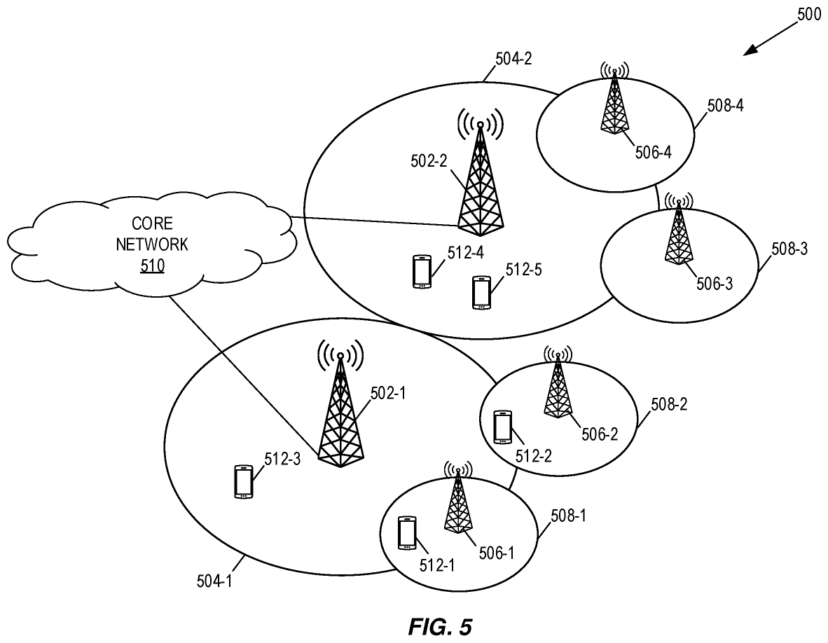

FIG. 5 illustrates one example of a cellular communications system 500 in which embodiments of the present disclosure may be implemented. In the embodiments described herein, the cellular communications system 500 is a 5G system (5GS) including a Next Generation RAN (NG-RAN) and a 5G Core (5GC); however, the solutions described herein are not limited thereto. In this example, the RAN includes base stations 502-1 and 502-2, which in the 5GS include NR base stations (gNBs) and optionally next generation eNBs (ng-eNBs) (e.g., LTE RAN nodes connected to the 5GC), controlling corresponding (macro) cells 504-1 and 504-2. The base stations 502-1 and 502-2 are generally referred to herein collectively as base stations 502 and individually as base station 502. Likewise, the (macro) cells 504-1 and 504-2 are generally referred to herein collectively as (macro) cells 504 and individually as (macro) cell 504. The RAN may also include a number of low power nodes 506-1 through 506-4 controlling corresponding small cells 508-1 through 508-4. The low power nodes 506-1 through 506-4 can be small base stations (such as pico or femto base stations) or Remote Radio Heads (RRHs), or the like. Notably, while not illustrated, one or more of the small cells 508-1 through 508-4 may alternatively be provided by the base stations 502. The low power nodes 506-1 through 506-4 are generally referred to herein collectively as low power nodes 506 and individually as low power node 506. Likewise, the small cells 508-1 through 508-4 are generally referred to herein collectively as small cells 508 and individually as small cell 508. The cellular communications system 500 also includes a core network 510, which in the 5G System (5GS) is referred to as the 5GC. The base stations 502 (and optionally the low power nodes 506) are connected to the core network 510.

The base stations 502 and the low power nodes 506 provide service to wireless communication devices 512-1 through 512-5 in the corresponding cells 504 and 508. The wireless communication devices 512-1 through 512-5 are generally referred to herein collectively as wireless communication devices 512 and individually as wireless communication device 512. In the following description, the wireless communication devices 512 are oftentimes UEs and as such sometimes referred to herein as UEs 512, but the present disclosure is not limited thereto.

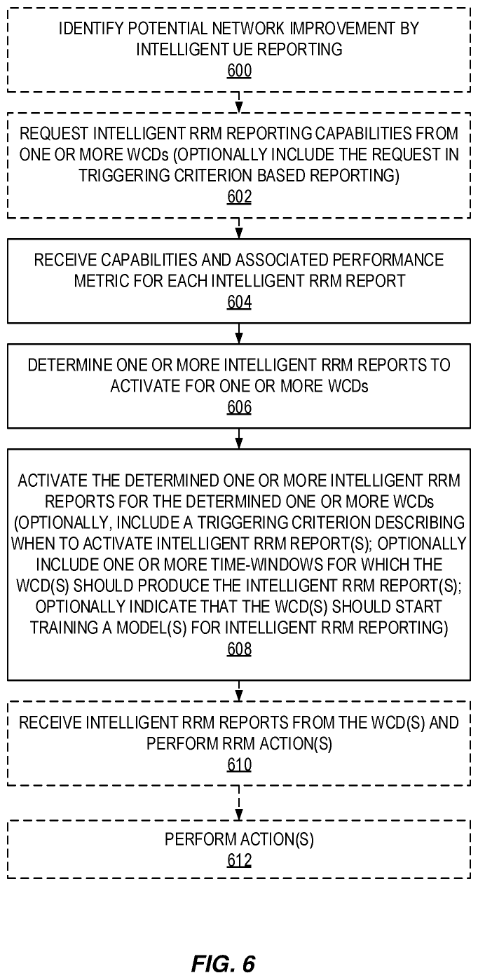

FIG. 6 is a flow chart that illustrates the operation of a network node (e.g., a base station 502 or a network node that implements functionality of a component of a base station 502, such as, e.g., a gNB-CU or gNB-CU-CP of a gNB) in accordance with an embodiment of the present disclosure. Optional steps are represented by dashed lines/boxes. As illustrated, the network node identifies (i.e., determines) that there is a potential for network improvement (e.g., network performance improvement) by intelligent RRM reporting from at least some of the wireless communication devices 512 (step 600). In other words, the network node determines that intelligent RRM reporting is to be activated. For example, the network node may identify that there is a potential for network improvement by intelligent RRM reporting based on a current performance of the network node (e.g., number of radio link failures), network information (e.g. load) (e.g., only activate intelligent RRM reporting when the network is likely experience complex situations), information about wireless communication devices (e.g., number of wireless communication devices), historical information, or the like. The network node (e.g., responsive to identifying the potential for network improvement by intelligent RRM reporting from wireless communication devices 512) requests capabilities for intelligent RRM reporting from one or more wireless communication devices 512 (step 602). In other words, the network nodes sends, to one or more wireless communication devices 512, a request for capabilities of the one or more wireless communication devices 512 for intelligent RRM reporting. Optionally, the request includes a capability request for triggering criterion-based reporting.

The network node receives information that indicates capabilities of one or more wireless communication devices 512 for intelligent RRM reporting (step 604). The information in step 604 may be received in response to the request of step 602. The received information may also include information that indicates a performance metric for each intelligent RRM report supported by the wireless communication device 512.

The network node determines one or more intelligent RRM reports to be activated and one or more wireless communication devices 512 for which the intelligent RRM reports are to be activated, based on the received capability information from step 604 (step 606). The network node then activates the determined intelligent RRM report(s) for the determined wireless communication device(s) 512 (step 608). In other words, the network node sends a message(s) to the determined wireless communication device(s) 512 that instruct the determined wireless communication device(s) 512 to activate the determined intelligent RRM report(s). Optionally, message(s) sent to the wireless communication device(s) 512 to activate the intelligent RRM report(s) may include a triggering criterion that describes when to activate the intelligent RRM report(s). Optionally, the message(s) may include information that indicates one or more time-windows for which the wireless communication device(s) is to produce the intelligent RRM report(s). Optionally, the message(s) may include information that indicates that the wireless communication device(s) 512 are to start training a model (e.g. a ML model such as, e.g., a neural network) for intelligent RRM reporting. For example, the network node may only activate the intelligent RRM report(s) during a time period(s) when such reporting is useful where the time period(s) can be based on, e.g., networking scheduling and/or UE service type. Further, the determined wireless communication device(s) 512 for which the intelligent RRM report(s) are activated may be selected based on the capabilities of those wireless communication device(s) 512. Further, in one embodiment, intelligent RRM reporting is triggered when it fulfills a certain accuracy requirement. The accuracy requirement may be configured by the network node or predefined or otherwise known to the wireless communication device(s) 512. In one embodiment, prioritization of the intelligent reporting process at the wireless communication device(s) 512 may be ensured by providing the wireless communication device(s) 512 with priority levels for the reporting process so that lower priority processes can, if needed, be deferred or interrupted in favor of higher priority processes.

The network node may then receive the activated intelligent RRM report(s) from the wireless communication device(s) for which it(they) are activated and perform one or more RRM actions based on these reports (step 610).

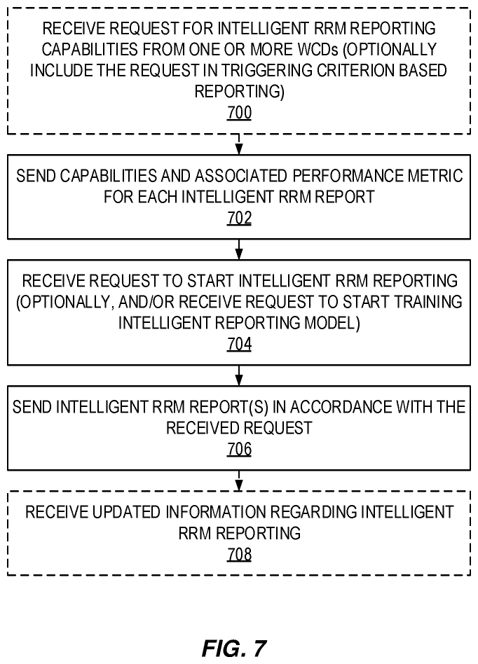

FIG. 7 is a flow chart that illustrates the operation of a wireless communication device 512 in accordance with an embodiment of the present disclosure. Optional steps are represented by dashed lines/boxes. As illustrated, the wireless communication device 512 receives, from a network node, a request for intelligent RRM reporting capabilities of the wireless communication device 512 (step 700). Optionally, the request includes a capability request for triggering criterion-based reporting. The wireless communication device 512 sends, to the network node, information that indicates the capabilities of the wireless communication device 512 for intelligent RRM reporting (step 702).

The wireless communication device 512 receives, from a network node, a request to start intelligent RRM reporting and/or a request to start training a model (e.g., a ML model such as, e.g., a neural network) for intelligent RRM reporting (step 704). Optionally, the message(s) received by the wireless communication device 512 to activate the intelligent RRM reporting may include a triggering criterion that describes when to activate the intelligent RRM report. Optionally, the message(s) may include information that indicates one or more time-windows for which the wireless communication device 512 is to produce intelligent RRM reports. Optionally, the message(s) may include information that indicates that the wireless communication device 512 is to start training a model (e.g. a ML model such as, e.g., a neural network) for intelligent RRM reporting. For example, the network node may only activate the intelligent RRM report(s) during a time period(s) when such reporting is useful where the time period(s) can be based on, e.g., networking scheduling and/or UE service type. Further, in one embodiment, intelligent RRM reporting is triggered when it fulfills a certain accuracy requirement. The accuracy requirement may be configured by the network node or predefined or otherwise known to the wireless communication device 512. In one embodiment, prioritization of the intelligent reporting process at the wireless communication device 512 may be ensured by priority information provided to the wireless communication device 512 (e.g., in step 704) that defines priority levels for the reporting process so that lower priority processes can, if needed, be deferred or interrupted in favor of higher priority processes.

The wireless communication device 512 performs one or more actions in response to the request received in step 704. More specifically, the wireless communication device 512 generates and sends an intelligent RRM report(s) to the network node in accordance with the received request of step 704 (step 706). Notably, as will be understood by those of skill in the art, in one embodiment, the request received in step 704 includes a request to train the machine-learning model used to produce the predicted values for the intelligent RRM report(s) prior to generating and sending the intelligent RRM report(s) in step 706. As such, in one embodiment, the one or more actions performed by the wireless communication device 512 in response to the request received in step 704 includes training the machine-learning model. The wireless communication device 512 may receive an update to information related to intelligent RRM reporting (e.g., an update to the triggering criterion, an update to deactivate intelligent RRM reporting, or the like) (step 708). The wireless communication device 512 then proceeds in accordance with the update.

Now, a discussion of numerous aspects that are related to the processes of FIGS. 6 and 7 will be provided. Note that the discussion of these aspects are applicable to the corresponding steps in the processes of FIGS. 6 and 7 and, as such, is to be understood as providing additional details for the processes of FIGS. 6 and 7. Note, however, that the described aspects are not limited to the processes of FIGS. 6 and 7.

I. When to Activate Intelligent RRM Capabilities Reporting?

Requesting intelligent RRM reporting capabilities of a wireless communication device 512 (e.g., in step 602 of FIG. 6 or step 700 of FIG. 7) could be done always on connection setup, or handover. However, there is a potential overhead in requesting for such information that should be minimized. In one embodiment, the decision of when to activate intelligent RRM capabilities is based on the activation steps below.

A. Performance Based

In one embodiment, the network node decides (e.g., in step 600 of FIG. 6) when to activate intelligent RRM reporting and thus when to request intelligent RRM reporting capabilities (e.g., in step 602 of FIG. 6) based on network performance. For example, the network node may decide to activate intelligent RRM reporting and thus to request intelligent RRM reporting capabilities when the RRM operation is not working properly (e.g., high number of radio-link failures, low throughput, high latency, etc.).

B. Energy Info.

In one embodiment, the network node decides (e.g., in step 600 of FIG. 6) when to activate intelligent RRM reporting and thus when to request intelligent RRM reporting capabilities based on energy information. For example, in one embodiment, the network node or wireless communication device 512 indicates having battery constraints and needs to reduce its energy consumption. For example, the network node or wireless communication device 512 may desire capabilities that can improve energy efficiency, for example desire to activate any or all types of procedures that replaces measurements with predictions, when the prediction is above a certain accuracy (as described by the triggering criterion).

C. Network Information

In one embodiment, the network node decides (e.g., in step 600 of FIG. 6) when to activate intelligent RRM reporting and thus when to request intelligent RRM reporting capabilities based on network information. This network information may include any one or more of the following examples:
Load, for example number of active UEs in nearby cells: The number of active UEs in nearby cells will degrade the performance by creating interference in a UE's serving cell. One could therefore expect worse, and less deterministic, channel conditions when the interference is high. Therefore, one could activate intelligent RRM reporting based on the neighboring cell-load.
Number of active UEs in current cell: The complexity in RRM increases when the load is higher, for example in scheduling and mobility. The delayed Channel Quality Indication (CQI) reporting can also increase with the higher load, leading to more uncertainty in the link-adaptation. Further, the resources in beamforming measurements might be less. It could also be used for admission control e.g., only allow intelligent UEs to connect in case of high load.
Number of inactive UEs transferred from nearby cells (or to nearby cells): Inactive UEs moving from cells of one network node (source node) to cells of another network node (target node) and resuming in the cell of the target node requires a UE Context fetch procedure and, for the case of resume initiated due to downlink activity, RAN paging will also be needed. Those UEs will experience a delay compared to the inactive users for which UE Context fetch and RAN Paging procedures are not needed. An indication of the amount of inactive UEs moving from/to nearby cells can be used by a network node to select, out of all such wandering UEs, which ones may be selected to follow their movements. The collected information on the UE movements may be used for RAN paging strategy optimization purposes or to prefetch the UE Context from neighbor nodes when UEs are predicted to move along a certain path, e.g. during a given time interval of the day.
Inappropriate coverage conditions, such as detection of excessively overlapping cell borders or detection of not sufficient overlapping between neighboring cells (implying a coverage hole).
Suboptimal mobility conditions, for example an excessive reception of Radio Link Failure (RLF) Reports from UEs indicating mobility failures or failures during the addition of new cells in multi connectivity, or reception of Successful Handover Reports, indicating the sub-optimal execution of mobility procedures

D. Base Station Capabilities

In one embodiment, the network node decides (e.g., in step 600 of FIG. 6) when to activate intelligent RRM reporting and thus when to request intelligent RRM reporting capabilities based on base station capabilities. For example, in order to leverage the intelligent RRM reporting by the wireless communication device(s) 512, some base stations 502 need to support, for example, reinforcement learning techniques in order to make use of the intelligent report. Some base stations 502 might not be able to make use of a UE reported future location estimate, or sensor measurement for example.

E. UE Info

In one embodiment, the network node decides (e.g., in step 600 of FIG. 6) when to activate intelligent RRM reporting and thus when to request intelligent RRM reporting capabilities based on wireless communication device information. The wireless communication device information may include, for example, wireless communication device service type. Different service types and radio bearer quality of service classes imply different requirements on the link performance.

F. Historical Information

In one embodiment, the network node decides (e.g., in step 600 of FIG. 6) when to activate intelligent RRM reporting and thus when to request intelligent RRM reporting capabilities based on historical information. In one embodiment, by creating a database of historical performance measurements related to intelligent RRM, the network can adapt the activation of intelligent RRM reporting (e.g., when a new wireless communication device with similar properties as a previously seen wireless communication device connects). For example, one could detect manufacturers that constantly report an erroneous predicted signal quality value, and should thus not be configured with intelligent reporting.

II. Selecting and Activating Intelligent RRM Reporting

A. Select a Number of Wireless Communication Devices for Intelligent Reporting

The network node (e.g., base station 502 such as, e.g., a gNB) can select a certain number of UEs to use intelligent RRM reporting (e.g., in step 606 of FIG. 6). For example, the network node may select the wireless communication devices 512 that have reported, in their capabilities, the best average accuracy in reporting a certain value. Other wireless communication devices 512 can instead be selected for measuring a certain quantity instead. For example, some wireless communication devices 512 can be configured to signal a predicted inter-frequency signal quality value, while other wireless communication devices 512 can be configured to measure said frequency.

It should be noted that wireless communication devices 512 can be configured to report prediction information while being in RRC_Connected or while being in other states, e.g. RRC_Idle or RRC_Inactive.

RRC_Connected: The serving network node is aware and in control of the process of configuration and reporting of prediction information. The serving network node can therefore select, configure, de-configure and re-configure a wireless communication device 512 as per criteria described herein.

RRC_Idle and RRC_Inactive: The serving network node may select and configure a wireless communication device 512 for intelligent RRM reporting; however the wireless communication device 512 might move to the coverage area of other network nodes while being configured with the intelligent RRM reporting configuration. In this case, there are two options to handle the intelligent RRM reporting process:
Option 1: When the wireless communication device 512 moves to RRC_Connected state, the new serving network node is informed by an external system (e.g. the previously serving network node or a previously serving core network function) of the Intelligent RRM Reporting configuration at the wireless communication device 512. The new serving network node decides whether to deconfigure, reconfigure, or leave unaltered the ongoing configuration at the wireless communication device 512.
Option 2: When the wireless communication device 512 moves to RRC_Connected state, the wireless communication device 512 reports to the new serving network node details about its Intelligent RRM Reporting configuration. This could be done in addition to reporting the results of the Intelligent RRM Prediction, which in turn could be triggered by conditions being fulfilled and therefore triggering the reporting. In this case, the new serving network node becomes aware of the ongoing configuration at the wireless communication device 512 and is able to manage it (e.g. deconfigure, reconfigure, or leave unaltered).
Alternatively, the wireless communication device 512 might not report information about an ongoing Intelligent Reporting configuration to the serving network node. Instead, the wireless communication device 512 might simply report predictions when the configured conditions are fulfilled and adopt or reject or defer new intelligent reporting configuration based on the prioritization level that the network node has given to each of the intelligent reporting configurations being signaled to the wireless communication device 512.

B. Triggering Criterion

The network node can signal a triggering criterion to the wireless communication device 512 describing when the wireless communication device 512 should activate intelligent RRM reporting. This may be in case of replacing measurements with predictions or in case or reporting both measured values and predicted events. This triggering criterion may be signaled to the wireless communication device 512 in step 608 of FIG. 6 or received by the wireless communication device 512 in step 704 of FIG. 7. For example, the wireless communication device 512 can be configured to report predictions when its prediction accuracy is within a threshold range (for example x dB). The threshold can depend on the RRM operation. For example, a link-adaptation operation might require higher accuracy than a mobility operation.

In another example, in case of future signal quality prediction, the wireless communication device 512 may be configured with a triggering criterion such that the wireless communication device 512 only sends the predictions if its prediction performance is within a certain threshold range for the last x seconds, e.g., for a specific reference signal. The threshold and time window could be configured by the network. In case of a future value predicted, the network node can request a predicted value for a set of future time instances, for example based on its scheduling state.

In another embodiment, the network node triggers a periodical reporting of the predicted value at the wireless communication device 512. In other words, the triggering criterion may be a time-based criterion that triggers periodical reporting of the predicted value.

At the time of triggering an intelligent reporting process, the network node can also assign to the wireless communication device 512 a priority for the prediction process (e.g., in step 608 of FIG. 6 or step 704 of FIG. 7). This is because the wireless communication device 512 might be configured to also collect information and derive predictions that persist also when moving from RAN node to RAN node. An example could be a wireless communication device 512 that is tasked to collect inputs and calculate predictions when it is in RRC_Idle and report such predictions when certain conditions are fulfilled. This wireless communication device 512 will then need to be given a priority level for the process of measuring, predicting and reporting to the RAN upon occurrence of given events, so that a new prediction report configuration would not overwrite an existing ongoing one unless its priority is higher than the ongoing one.

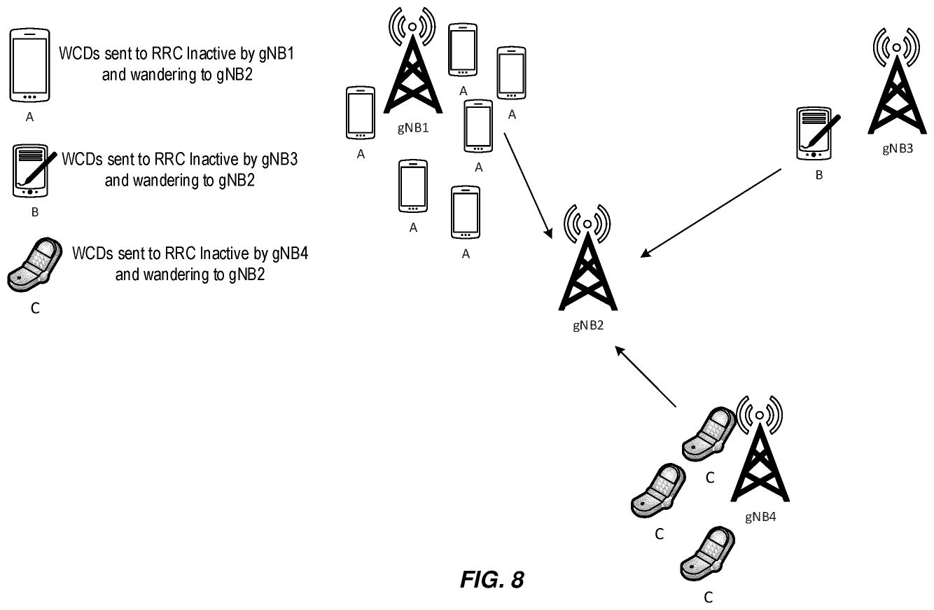

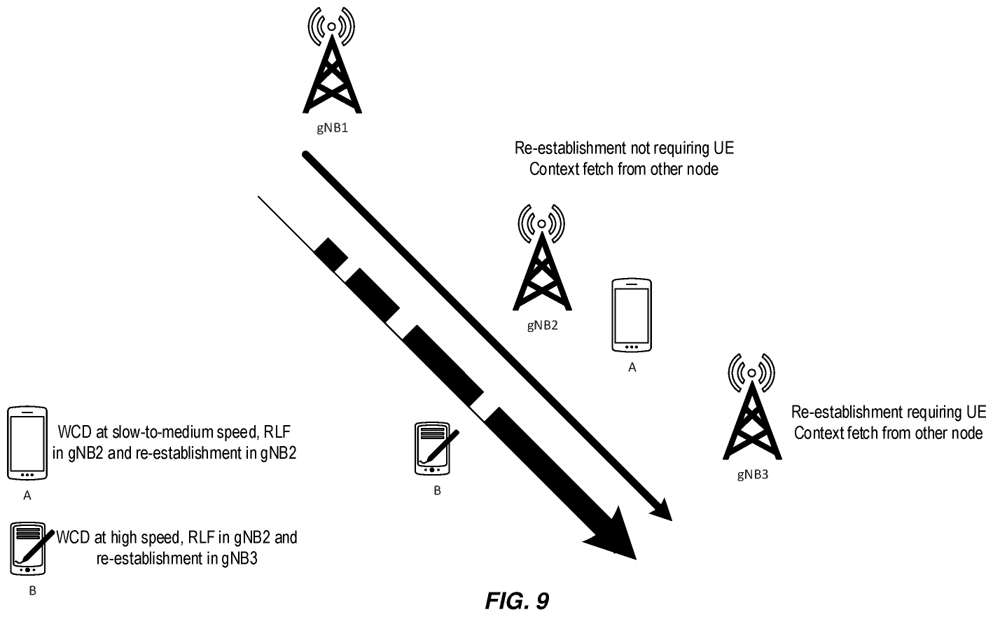

In another embodiment, the network node can trigger the reporting of predicted values based various aspects such as:
the wireless communication device 512 has certain radio related capabilities available at the network, e.g. support for specific band combinations, certain number of carriers, measurement related capability. This may be e.g. an indication of high-end terminals usually associated to premium users. Similarly, the triggering could be based on the type of wireless communication device, e.g., whether the wireless communication devices 512 is a robot or a human controlled terminal, whether the wireless communication device 512 is part of an ultra-reliable network (supporting Ultra Reliable services), etc.
the wireless communication device 512 is capable of certain services (e.g. Multicast/Broadcast Multimedia Service (MBMS)) and has subscribed to such services
the wireless communication device 512 is configured with specific Quality of Service (QoS) attributes (e.g. Guaranteed Flow Bit Rate (GFBR) for uplink (UL) and downlink (DL), Maximum Packet Loss Rate for UL and DL)
the network has detected a degradation (or an improvement) of QoS parameters associated to UE (e.g. Packet Loss, Packet delay, throughput)
the wireless communication device 512 is configured to report QoE measurements for at least one specific application (e.g. Voice over Long Term Evolution (VoLTE), streaming)
the network has detected a degradation (or an improvement) of the Quality of Experience (QoE) metrics reported by the wireless communication device 512 for one or multiple applications running at the wireless communication device 512
the wireless communication device 512 has a specific Service Profile Identifier (SPID)
the wireless communication device 512 is served by a certain slice
the wireless communication device 512 is known to be static
the wireless communication device 512 is within a certain area within which such triggering is allowed and started
   such area may be configured to comprise:
      an area served by a Standalone Non-Public Network (SNPN) or a Public Network Integrated Non-Public Network (PNI-NPN)
      an area served by an Integrated Access and Backhual (IAB) node
      a predefined geographical area
the network has received policies from other entities (such as 5GC or Operations and Management (OAM)) to follow a specific wireless communication device or a group of wireless communication devices
the network node previously triggered for the wireless communication device 512 or group of wireless communication devices 512 for which the node has fetched the UE Access Stratum (AS) Context from another node or for which RAN Paging is used. A possible motivation for this would be to follow the movement pattern for Inactive wireless communication devices 512. This will allow for a reduction of delay in resume, e.g. by optimizing RAN paging strategy or pre-fetch some UE Contexts from neighbor nodes (see FIG. 8). Another motivation for this would be to follow a scenario of Re-establishment to a cell other than the one towards which the original establishment was attempted and for which a fetch of UE is possible (see FIG. 9).

III. Intelligent RRM Report

The wireless communication device 512 can signal its capabilities in predicting a certain quantity (e.g., in step 604 of FIG. 6 or step 702 of FIG. 7). The capabilities can also include a performance metric describing the accuracy of the prediction. This could be represented with average values over a certain interval of time, standard deviation, maximum or minimum value, etc.

A. Measurement Replacement

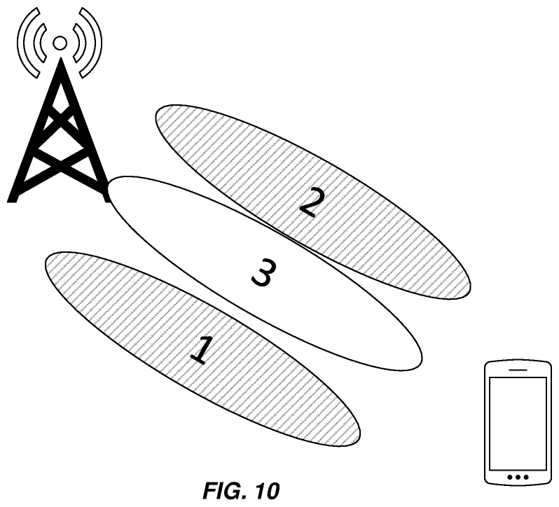

An intelligent wireless communication device 512 (i.e., a wireless communication device 512 capable of intelligent RRM reporting) can reduce its need for beam measurements and, for example, use a subset of beam measurements and predict the rest. For example, the wireless communication device 512 could measure 2-beams, but provide e.g. 3 beam-reports (e.g., in step 706 of FIG. 7) by predicting a value for the 3 rd beam using a ML model or AI (see, e.g., FIG. 10). As another example, the wireless communication device 512 could measure on one frequency, but also provide an estimate (e.g., in step 706 of FIG. 7) on other frequencies by predicting the estimate on the other frequencies. Activating this type of intelligent RRM report could be based on network load level for example. In one embodiment, for each intelligent RRM report, the wireless communication device 512 indicates (e.g., in step 706 of FIG. 7) an uncertainty of the predicted beams (non-measured beams), or frequency. The network node can use this information when selecting the beam for the wireless communication device 512. The network node can also configure a triggering criterion (e.g., in step 608 of FIG. 6) detailing the needed accuracy for each beam or frequency. In one embodiment, the wireless communication device 512 switches from predicting to measuring if the needed accuracy cannot be met.

B. Future Traffic

The network node can request (e.g., in step 608 of FIG. 6) the wireless communication device 512 to report predicted future traffic. Where the wireless communication device 512 can for example report a prediction of its traffic need for a certain time instance or a certain period of time in the future using a respective model.

C. Other Type of Information

The capabilities (e.g., reported by the wireless communication device in step 702 of FIG. 7 and received by the network node in step 604 of FIG. 6) can also support other types of info that can be used to select an RRM action. Parameters describing the physical state of a wireless communication device 512 may include parameters describing battery power, memory, processing or computational capacity, sensor values obtained from sensors associated with the device (accelerometers, pressure sensors, light sensors, etc.). Parameters describing the physical environment experienced by the wireless communication device 512 obtained using cameras, LIDARs, GNSS, etc. and may include parameters such as geolocation, indoor/outdoor estimation, physical velocity or acceleration, nearby infrastructure detected (buildings, roads, etc.), nearby natural features detected (hills, mountains etc.), device in bag/pocket detected, nearby detected antenna towers.

IV. CU-CP and DU-CP Aspects

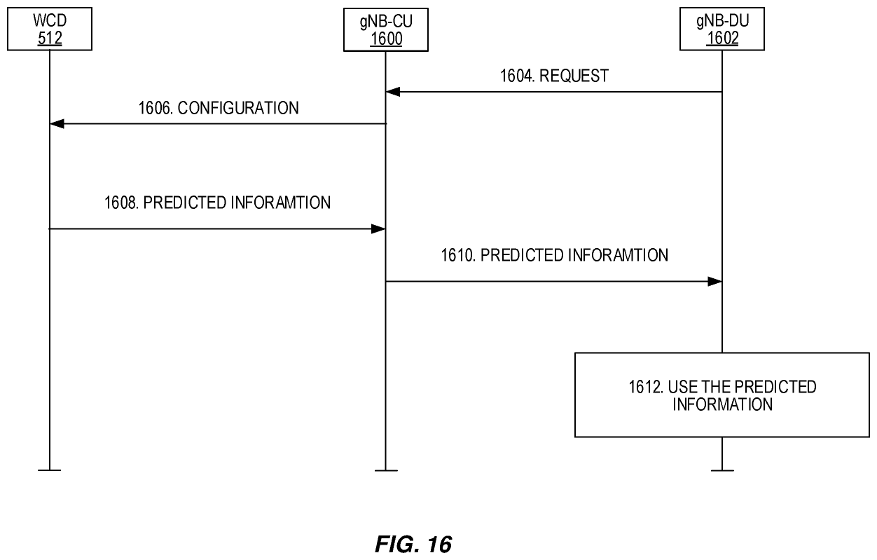

In one embodiment, the network node in charge of managing Intelligent Reporting from the wireless communication device 512 is a gNB-CU. However, it is possible for an associated gNB-DU to task the gNB-CU with configuration of specific Intelligent Reporting processes that might be beneficial for the gNB-DU 1602. In such case, as illustrated in FIG. 16, a gNB-CU 1600 may, on request from a gNB-DU 1602, configure the wireless communication device 512 (steps 1604 and 1606). If the gNB-CU 1600 receives predicted information from the wireless communication device 512 (step 1608), the gNB-CU 1600 may forward the predicted information to the gNB-DU 1602 (step 1610), which in turn may make use of the predicted information to optimize its handled processes (step 1612).

An example of this embodiment could include the gNB-DU requesting predictions on beam level coverage for the served beams and for neighbor cell beams. The gNB-DU may use such predictions to optimize management of its served beams and for example to shape or extend or reduce beam coverage or to increase or reduce the number of beams serving a given area.

V. Additional Description

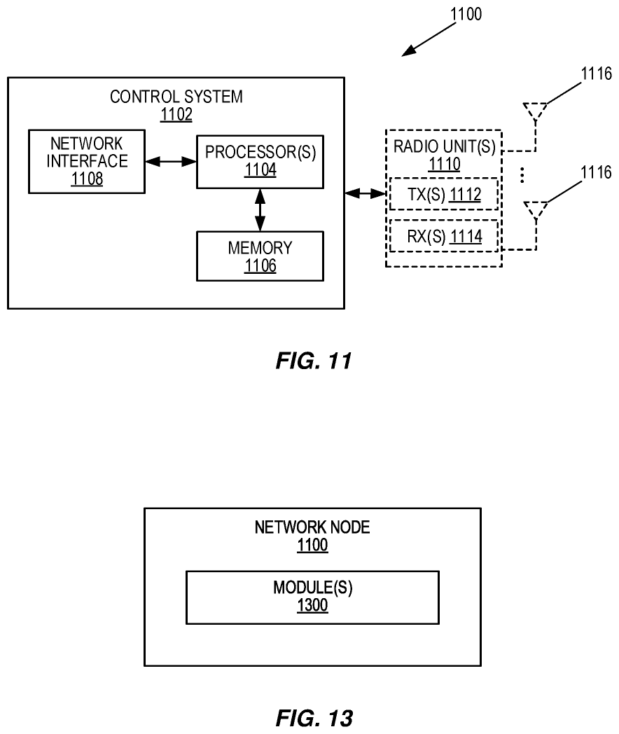

FIG. 11 is a schematic block diagram of a network node 1100 according to some embodiments of the present disclosure. Optional features are represented by dashed boxes. The network node 1100 may be, for example, a base station 502 or 506 or a network node that implements all or part of the functionality of the base station 502 or gNB described herein. As illustrated, the network node 1100 includes a control system 1102 that includes one or more processors 1104 (e.g., Central Processing Units (CPUs), Application Specific Integrated Circuits (ASICs), Field Programmable Gate Arrays (FPGAs), and/or the like), memory 1106, and a network interface 1108. The one or more processors 1104 are also referred to herein as processing circuitry. In addition, if the network node 1100 is a radio access node (e.g., a base station 502/506), the network node 1100 may include one or more radio units 1110 that each includes one or more transmitters 1112 and one or more receivers 1114 coupled to one or more antennas 1116. The radio units 1110 may be referred to or be part of radio interface circuitry. In some embodiments, the radio unit(s) 1110 is external to the control system 1102 and connected to the control system 1102 via, e.g., a wired connection (e.g., an optical cable). However, in some other embodiments, the radio unit(s) 1110 and potentially the antenna(s) 1116 are integrated together with the control system 1102. The one or more processors 1104 operate to provide one or more functions of the network node 1100 as described herein (e.g. one or more functions of a network node, base station 502/506, gNB, gNB-CU, gNB-DU, or the like, as described herein). In some embodiments, the function(s) are implemented in software that is stored, e.g., in the memory 1106 and executed by the one or more processors 1104.

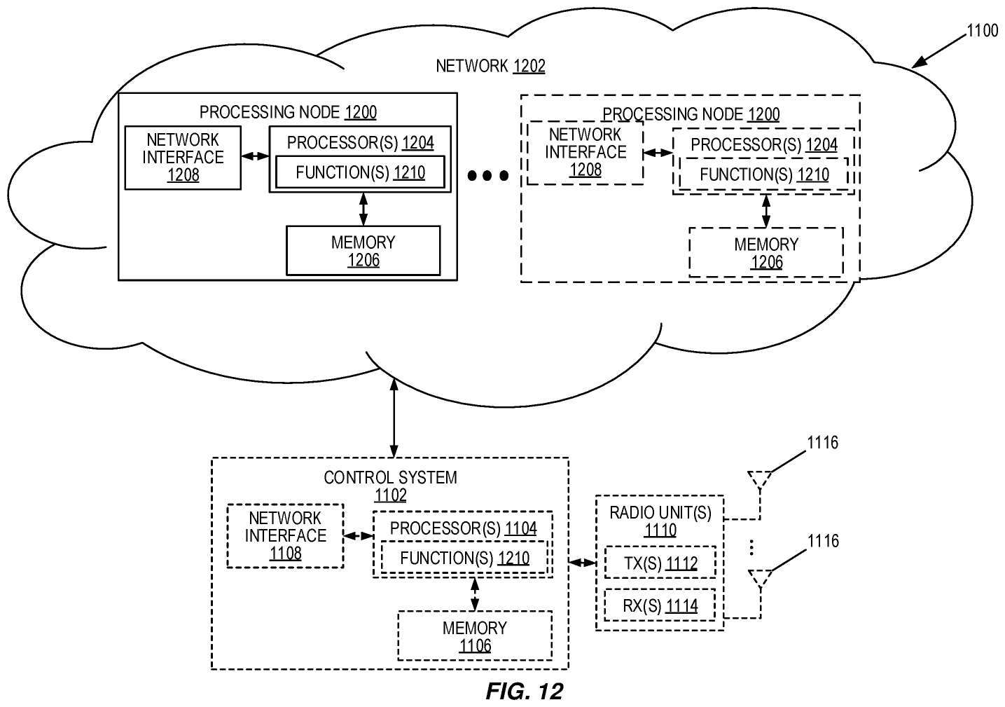

FIG. 12 is a schematic block diagram that illustrates a virtualized embodiment of the network node 1100 according to some embodiments of the present disclosure. Again, optional features are represented by dashed boxes. As used herein, a “virtualized” network node is an implementation of the radio access node 1100 in which at least a portion of the functionality of the network node 1100 is implemented as a virtual component(s) (e.g., via a virtual machine(s) executing on a physical processing node(s) in a network(s)). As illustrated, in this example, the network node 1100 includes one or more processing nodes 1200 coupled to or included as part of a network(s) 1202. Each processing node 1200 includes one or more processors 1204 (e.g., CPUs, ASICs, FPGAs, and/or the like), memory 1206, and a network interface 1208. If the network node 1100 is a radio access node, the network node 1100 may include the control system 1102 and/or the one or more radio units 1110, as described above. The control system 1102 may be connected to the radio unit(s) 1110 via, for example, an optical cable or the like. If present, the control system 1102 or the radio unit(s) are connected to the processing node(s) 1200 via the network 1202. In this example, functions 1210 of the network node 1100 described herein (e.g. one or more functions

of a network node, base station 502/506, gNB, gNB-CU, gNB-DU, or the like, as described herein) are implemented at the one or more processing nodes 1200 or distributed across the one or more processing nodes 1200 and the control system 1102 and/or the radio unit(s) 1110 in any desired manner. In some particular embodiments, some or all of the functions 1210 of the network node 1100 described herein are implemented as virtual components executed by one or more virtual machines implemented in a virtual environment(s) hosted by the processing node(s) 1200. As will be appreciated by one of ordinary skill in the art, additional signaling or communication between the processing node(s) 1200 and the control system 1102 is used in order to carry out at least some of the desired functions 1210. Notably, in some embodiments, the control system 1102 may not be included, in which case the radio unit(s) 1110 communicate directly with the processing node(s) 1200 via an appropriate network interface(s).

In some embodiments, a computer program including instructions which, when executed by at least one processor, causes the at least one processor to carry out the functionality of the network node 1100 or a node (e.g., a processing node 1200) implementing one or more of the functions 1210 of the network node 1100 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 13 is a schematic block diagram of the network node 1100 according to some other embodiments of the present disclosure. The network node 1100 includes one or more modules 1300, each of which is implemented in software. The module(s) 1300 provide the functionality of the network node 1100 described herein (e.g. one or more functions of a network node, base station 502/506, gNB, gNB-CU, gNB-DU, or the like, as described herein). This discussion is equally applicable to the processing node 1200 of FIG. 12 where the modules 1300 may be implemented at one of the processing nodes 1200 or distributed across multiple processing nodes 1200 and/or distributed across the processing node(s) 1200 and the control system 1102.

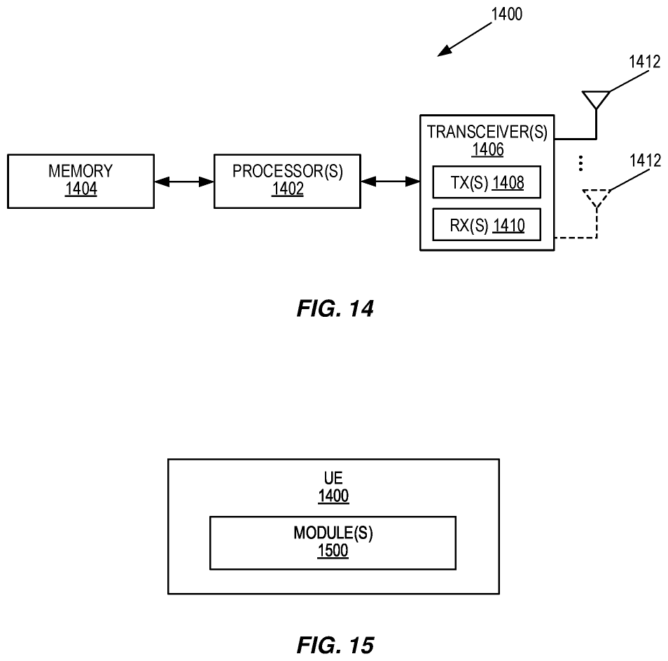

FIG. 14 is a schematic block diagram of a wireless communication device 1400 (e.g., the wireless communication device 512) according to some embodiments of the present disclosure. As illustrated, the wireless communication device 1400 includes one or more processors 1402 (e.g., CPUs, ASICs, FPGAs, and/or the like), memory 1404, and one or more transceivers 1406 each including one or more transmitters 1408 and one or more receivers 1410 coupled to one or more antennas 1412. The transceiver(s) 1406 includes radio-front end circuitry connected to the antenna(s) 1412 that is configured to condition signals communicated between the antenna(s) 1412 and the processor(s) 1402, as will be appreciated by on of ordinary skill in the art. The processors 1402 are also referred to herein as processing circuitry. The transceivers 1406 are also referred to herein as radio circuitry. In some embodiments, the functionality of the wireless communication device 1400 described above (e.g. one or more functions of the wireless communication device 512 or UE, as described herein) may be fully or partially implemented in software that is, e.g., stored in the memory 1404 and executed by the processor(s) 1402. Note that the wireless communication device 1400 may include additional components not illustrated in FIG. 14 such as, e.g., one or more user interface components (e.g., an input/output interface including a display, buttons, a touch screen, a microphone, a speaker(s), and/or the like and/or any other components for allowing input of information into the wireless communication device 1400 and/or allowing output of information from the wireless communication device 1400), a power supply (e.g., a battery and associated power circuitry), etc.

In some embodiments, a computer program including instructions which, when executed by at least one processor, causes the at least one processor to carry out the functionality of the wireless communication device 1400 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 15 is a schematic block diagram of the wireless communication device 1400 according to some other embodiments of the present disclosure. The wireless communication device 1400 includes one or more modules 1500, each of which is implemented in software. The module(s) 1500 provide the functionality of the wireless communication device 1400 described herein (e.g. one or more functions of the wireless communication device 512 or UE, as described herein).

Some example embodiments of the present disclosure are as follows:

Embodiment 1: A method performed by a wireless communication device (512), the method comprising one or more of the following actions:
sending (702), to a network node, information that indicates one or more capabilities of the wireless communication device (512) for reporting of predicted values (e.g., predicted RRM related values) that are predicted by the wireless communication device (512) using machine learning or artificial intelligence (e.g., one or more capabilities of the wireless communication device (512) for intelligent RRM reporting);
receiving (704), from the network node (e.g., the network node), a request, the request comprising: (a) a request to start reporting predicted values (e.g., to start intelligent RRM reporting), (b) a request to start training a machine learning or artificial intelligence model for generating predicted values, or (c) both (a) and (b); and performing one or more actions in response to receiving the request.

Embodiment 2: The method of embodiment 1 wherein performing the one or more actions comprises:
generating (706) one or more reports (e.g., intelligent RRM reports) comprising one or more predicted values based on a machine learning or artificial intelligence model; and
sending (706) the one or more reports to the network node.

Embodiment 3: The method of embodiment 2 wherein the one or more reports further comprise information that indicates an accuracy or confidence level of the one or more predicted values.

Embodiment 4: The method of any of embodiments 1 to 3 wherein reporting of predicted values is activated when a triggering criterion is satisfied.

Embodiment 5: The method of embodiment 4 wherein the triggering criterion is a required accuracy level for the one or more predicted values.

Embodiment 6: The method of embodiment 4 wherein the triggering criterion is a time-based triggering criterion.

Embodiment 7: The method of embodiment 4 wherein the triggering criterion is a prediction performance based triggering criterion.

Embodiment 8: The method of any of embodiments 1 to 7 wherein the request comprises a request to start reporting predicted values at a particular time(s) or during a particular time window(s).

Embodiment 9: The method of any of embodiments 1 to 8 wherein the predicted values comprise predicted RRM related values.

Embodiment 10: The method of any of embodiments 1 to 8 wherein the predicted values comprise predicted beam related values.

Embodiment 11: The method of any of embodiments 1 to 8 wherein the predicted values comprise predicted measurement values for one or more frequencies.

Embodiment 12: The method of any of embodiments 1 to 8 wherein the predicted values comprise predicted values for future traffic needs of the wireless communication device (512).

Embodiment 13: The method of any of embodiments 1 to 12 further comprising:
receiving (700) a request from the network node for the one or more capabilities of the wireless communication device (512) for reporting of predicted values;
wherein sending (702) the information that indicates the one or more capabilities of the wireless communication device (512) for reporting of predicted values comprises sending (702) the information that indicates the one or more capabilities of the wireless communication device (512) for reporting of predicted values responsive to receiving (700) the request from the network node for the one or more capabilities of the wireless communication device (512) for reporting of predicted values.

Embodiment 14: A wireless communication device (512) adapted to perform the method of any of embodiments 1 to 13.

Embodiment 15: A wireless communication device (512; 1400) comprising:
one or more transmitters (1408);
one or more receivers (1410); and
processing circuitry (1402) associated with the one or more transmitters (1408) and the one or more receivers (1410), the processing circuitry (1402) configured to cause the wireless communication device (512; 1400) to perform the method of any of embodiments 1 to 13.

Embodiment 16: A method performed by a network node (1100; 502), the method comprising one or more of the following actions:
receiving (604), from a plurality of wireless communication devices (512), information that indicates one or more capabilities of the plurality of wireless communication devices (512) for reporting of predicted values (e.g., predicted RRM related values) (e.g., one or more capabilities of the plurality of wireless communication devices (512) for intelligent RRM reporting);
determining (606) one or more wireless communication devices (512) from which to request reporting of predicted values from the plurality of wireless communication devices (512) based on the received information and/or determining (606) one or more reports to request from one or more wireless communication devices (512) from among the plurality of wireless communication devices (512) based on the received information;
sending (608), to the one or more wireless communication devices (512), a request, the request comprising: (a) a request to start reporting predicted values (e.g., to start intelligent RRM reporting), (b) a request to start training a machine learning or artificial intelligence model for generating predicted values, or (c) both (a) and (b).

Embodiment 17: The method of embodiment 16 further comprising receiving (710) one or more reports from the one or more wireless communication devices (512), the one or more reports comprising predicted values.

Embodiment 18: The method of embodiment 17 further comprising performing one or more actions (e.g., one or more RRM related actions) based on the one or more reports.

Embodiment 19: The method of embodiment 17 or 18 wherein the one or more reports further comprise information that indicates an accuracy or confidence level of the predicted values.

Embodiment 20: The method of any of embodiments 17 to 19 further comprising sending (708), to the one or more wireless communication devices (512), a triggering criterion that defines when reporting of predicted values is to be activated at the one or more wireless communication devices (512).

Embodiment 21: The method of embodiment 20 wherein the triggering criterion is a required accuracy level for the one or more predicted values.

Embodiment 22: The method of embodiment 20 wherein the triggering criterion is a time-based triggering criterion.

Embodiment 23: The method of embodiment 20 wherein the triggering criterion is a prediction performance based triggering criterion.

Embodiment 24: The method of any of embodiments 16 to 23 wherein the request comprises a request to start reporting predicted values at a particular time(s) or during a particular time window(s).

Embodiment 25: The method of any of embodiments 16 to 24 wherein the predicted values comprise predicted RRM related values.

Embodiment 26: The method of any of embodiments 16 to 24 wherein the predicted values comprise predicted beam related values.

Embodiment 27: The method of any of embodiments 16 to 24 wherein the predicted values comprise predicted measurement values for one or more frequencies.

Embodiment 28: The method of any of embodiments 16 to 24 wherein the predicted values comprise predicted values for future traffic needs of the wireless communication device (512).

Embodiment 29: The method of any of embodiments 16 to 28 further comprising sending (602), to the plurality of wireless communication devices (512), a request for the one or more capabilities of the wireless communication device (512) for reporting of predicted values.

Embodiment 30: A network node (1100; 502) adapted to perform the method of any of embodiments 16 to 29.

Embodiment 31: A network node (1100; 502) comprising processing circuitry (1104; 1204) configured to cause the network node (1100; 502) to perform the method of any of embodiments 16 to 29.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure. While processes in the figures may show a particular order of operations performed by certain

embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

VI. Additional Aspects

The following pages of the detailed description reproduce text of discussion papers prepared for 3GPP meeting #110-e. This text was included as an appendix to the priority founding application, provisional patent application Ser. No. 63/094,698, filed Oct. 21, 2020. Up to this section, the present disclosure has focused primarily on utilization machine learning to predict values for RRM use cases. However, there are a number of other use cases in which the methods of the present disclosure for generation of predicted values for machine-learned network optimization (e.g., as described with regards to FIGS. 6/7) can be used.

VI.A. AI/ML based Use Cases

1 Introduction

As described in RP-201620, the study on AI/ML in RAN3 will focus on the following:
This study item arms to study the functional framework for RAN intelligence enabled by further enhancement of data collection through use cases, examples etc. and identify the potential standardization impacts on current NG-RAN nodes and interfaces.
The detailed objectives of the SI are listed as follows:
Study high level principles for RAN intelligence enabled by AI, the functional framework (e.g. the AI functionality and the input/output of the component for AI enabled optimization) and identify the benefits of AI enabled NG-RAN through possible use cases e.g. energy saving, load balancing, mobility management, coverage optimization, etc.:
   1. Study standardization impacts for the identified use cases including: the data that may be needed by an AI function as input and data that may be produced by an AI function as output, which is interpretable for multi-vendor support. [ . . . ]
One general objective for the work is that the studies should be focused on the current NG-RAN architecture and interfaces to enable AI support for 5G deployments.

In order to explore the areas where AI/ML is most applicable and can improve the network performance for the NG RAN, this paper illustrates use cases that can be taken as reference during the development of AI/ML based solutions.

2 AI/ML Use Cases

It is important to fully utilize the potentials in AI/ML for wireless networks, for example by extracting important data from the system in order to build advanced AI/ML models.

One problem in enabling AI/ML for wireless networks is the variable cost depending on wired or over-the-air data transfer. Enabling AI/ML by extending the UE reporting over-the-air by including different types of information, from radio to physical measurements would lead to increased signalling. The trade-off between increased data signalling versus enabling improved intelligence at the network is a challenging problem. It is important to fully address such trade-offs when evaluating different AI/ML use cases in the SI. One alternative to extending the UE report of radio or physical measurements is to explore the use of potential augmented information provided by the UE, for example generated by an AI-model. This information may be given as input to AI models hosted in the network, hence creating a system where AI models interact between each other to produce the desired final output.

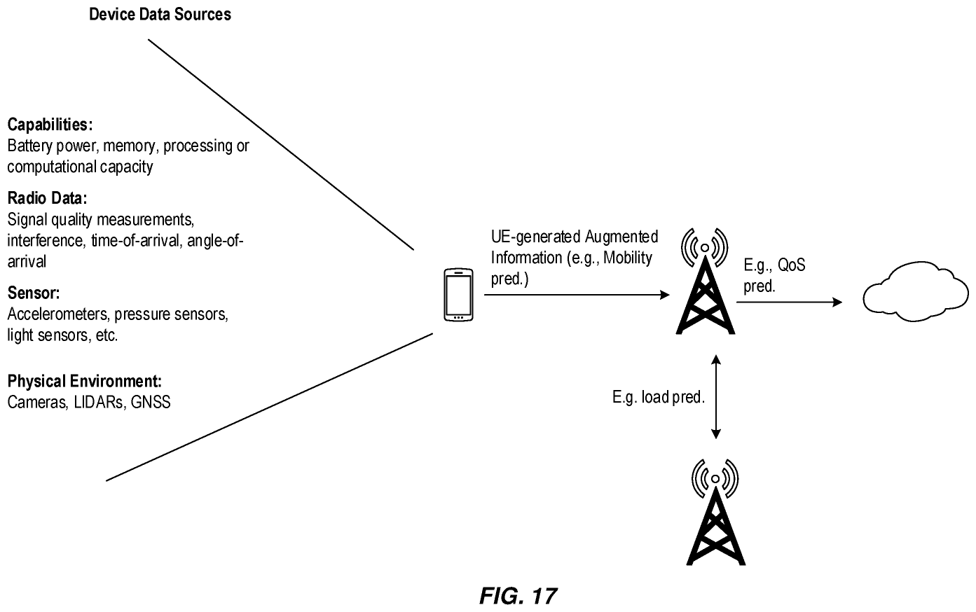

FIG. 17 shows an example of how multiple data sources can be used to create intelligent augmentation data at the UE and at RAN nodes.

Proposal 1: Explore Potential Augmented Information from the UE and from the RAN in Each Use Case.

Next, use cases covering important areas where AI/ML is likely to improve network performance is described. The use cases are classified in the following families:
1. AI/ML for traffic steering, both comprising
   Capacity improvements
   Energy efficiency
2. AI/ML for QoS prediction
3. AI/ML for improved radio resource management (RRM)

2.1 AI/ML for Traffic Steering

AI/ML can be applied to steer traffic more efficiently, both in terms of capacity and energy efficiency.

2.1.1 Reward Information for AI/ML-Based Handovers

Finding the best cell or set of cells to serve a UE is a challenging task due to the densification of networks and introduction of new frequency bands. One of the challenges in finding the best cell for a UE is to evaluate if the new cell was better than a previous serving cell for the UE, hence, it would be beneficial to have richer feedback information available from the new serving cell, so to compare previous and current serving cell performance.

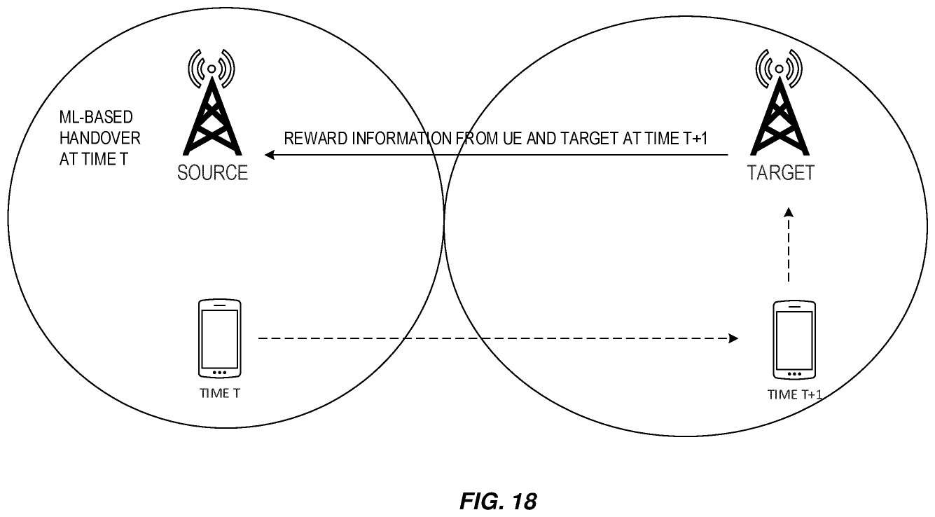

FIG. 18: The target provides reward information (feedback) on the UE performance after handover.

Considering the current handover mechanisms in NR, after a handover to the target cell, the source/serving node would act obliviously about the handed over UE i.e. it would not be interested on that UE any longer. Therefore, if the UE experiences low throughput or poor radio coverage once handed over to the target cell, the source node of the handover would not be able to recognize and take any counteraction preventing such handovers causing poor performance for the UE. It is thus important to design a solution enabling a feedback mechanism after handover, where the UE and the target node provide measurements relative to the performance of the target cell serving the UE. This can enable the source node to update its handover decisions frequently based on the received feedback from target node (which would comprise also feedback from the UE while at target). The feedback from the target could be used as reward information for an AI/ML function that performs handover decisions, one such function could comprise reinforcement learning. Handover decisions consist of a prediction that could take into account possible future performance for a UE once handed over to a certain target cell/node. The feedback provided from target RAN node to source could comprise of:
Dwelling time in cell
Measurements of QoS parameters experienced at target (instantaneous/mean)
UE traffic pattern after handover
Resource utilizations used by UE, experienced latency (e.g., E2E RTT), measure of transmission reliability
Radio efficiency at target cell (bit per second per hertz)
Any change in UEs service requirements
Mobility history information
Multi connectivity configurations adopted after HO.

Proposal 2: Investigate Potential Reward Information for Enabling AI/ML Based Traffic Steering

2.1.2 Traffic Steering Augmented Information

In addition to the reward information provided by the target RAN node, the potential target RAN node could also signal augmented information as illustrated in the message sequence chart below, generated by an ML-model for improved traffic steering, for example its future load information. The predicted future load information can comprise
Number of active UEs
Resource utilization
Available Capacity
Number of RRC Connections
TNL capacity

The UE may also provide augmented information such as its predicted mobility pattern and feed this to the target RAN, which in turn will forward it to the source RAN. Similarly, the serving gNB can provide the target gNB with augmented information related to the UE at handover, for example the predicted UE mobility or traffic.

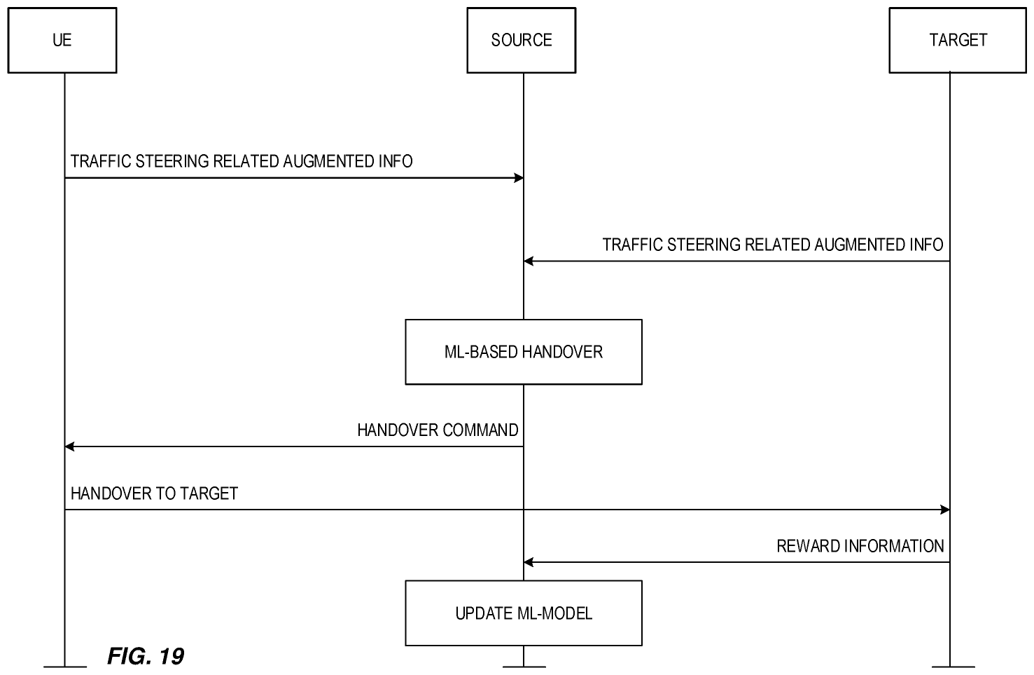

FIG. 19 is a message sequence chart for target cell prediction based on reward information and augmented information

Proposal 3: Augmented Information Related to Improved Traffic Steering should be Investigated

2.1.3 AI/ML for Energy Efficiency

Energy efficiency is an important aspect in wireless communications networks. One method for providing energy saving is to put capacity cells into a sleep mode. The activation or deactivation of a capacity cell may be triggered from a gNB that provides basic coverage as illustrated in the picture below and is typically a trade-off between energy efficiency and capacity.

In cases when there is quite low traffic around the capacity cell, it may be more energy efficient to turn off the capacity cell until the load increases. The capacity cell may later be activated when the traffic is higher and when there are UEs in the vicinity of the capacity cell which may be moved into the capacity cell by a handover procedure or some other connectivity reconfiguration procedure. However, it may be quite tricky to find out whether or not the communications UEs served by the basic coverage cell may be served by the capacity cell without activating the capacity cell. This means that in some situations when the load increases, the capacity cell is activated in order to determine whether or not one or more UEs served by the basic coverage cell may be served by the capacity cell. In case no such UEs would connect (or it would connect with acceptable radio conditions) to the activated capacity cell, the activation is done in vain, hence leading to a waste of energy.

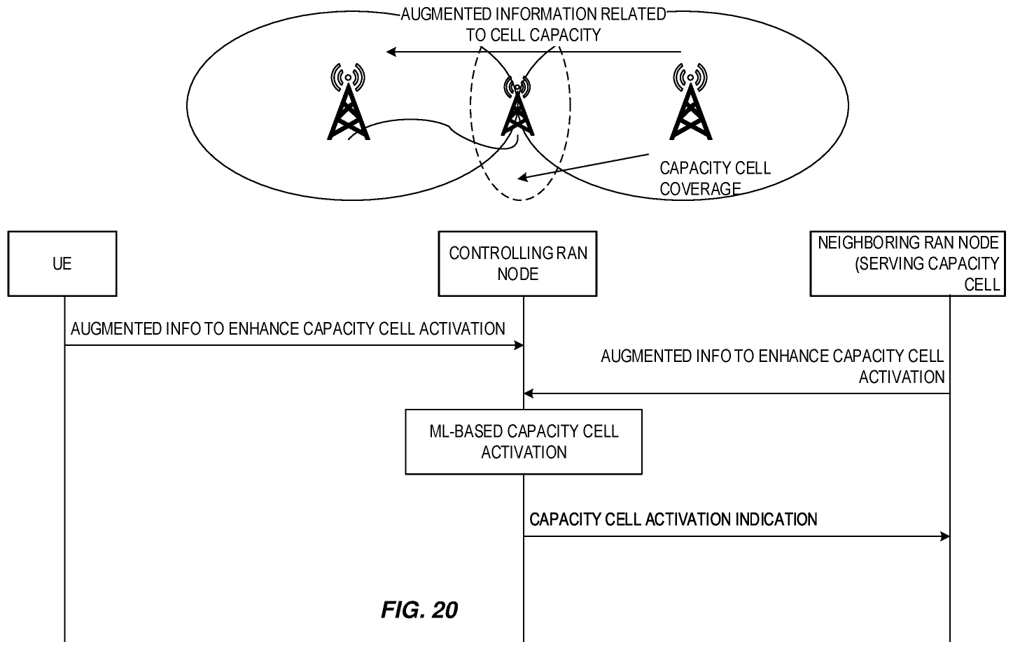

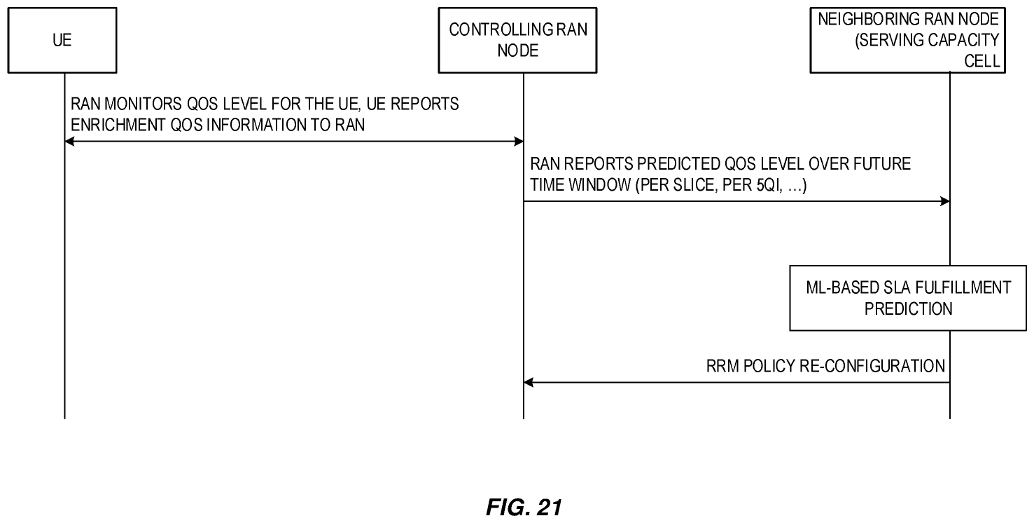

FIG. 20 illustrates capacity cell activation based on reward information and augmented information.

Furthermore, a capacity cell is often deployed in the handover region of two basic coverage cells, and therefore it is difficult to optimize capacity versus energy consumption. It is important to also look into energy saving application using ML/AI in activating capacity cells efficiently, for example to activate capacity cells based on predictions on traffic that could be offloaded to the capacity cell for all relevant nodes in the network. The signaling of such predictions to the RAN node controlling the activation or the signaling of information that may help to derive a prediction of offloaded traffic to capacity cell, should be investigated. It is also important to investigate whether the UE can provide augmented information to enable a smarter capacity cell activation.

Proposal 4: Energy Efficiency should be Studied, for Example AI/ML for Capacity Cell Activation

2.2 AI/ML for QoS Prediction

Quality of service (QoS) describes the overall performance of a service, for example the latency, reliability or throughput. Service Level Agreements (SLAs) are contractual agreements between an operator and an incumbent for the provisioning of services with a given set of performance requirements. On the basis of the current and predicted QoS target of each served UE, it is possible to determine if SLAs are going to be met. The system in charge for checking fulfillment of SLAs is the OAM. In order to enable better SLA fulfillment prediction at the OAM, one should look into AI/ML in order to provide augmented information helping to forecast SLA fulfilment.

Using AI/ML, the CU-CP can for example predict whether for a group of UEs and services (e.g. for UEs in a certain network slice using a service with 5QI==x) the target QoS requirements will be fulfilled or not. Such prediction can be relative to a specific time window into the future.

Such augmented information can also comprise non-UE specific information, such as a prediction of the expected load per QoS class for a particular time of the day, as well as a prediction of whether QoS requirements for such QoS classes can be fulfilled. The QoS fulfillment prediction could be signaled from the RAN to the OAM upon request from the OAM. The request could also comprise a request for the predicted QoS for a certain type of UE, for example a highly mobile UE or a low-end UE (e.g. IoT).

The OAM receiving such QoS fulfillment prediction can in turn derive whether SLAs can be fulfilled in the future. If for example the OAM determines that SLAs cannot be fulfilled in the future, the OAM can take preventive actions such as to reconfigure resource partition policies per slice at the RAN in order to ensure that the SLAs not fulfilled can be fulfilled by means of a higher amount of resources to be utilized. The general framework is illustrated in the flowchart below.

FIG. 21 illustrates QoS and SLA fulfillment prediction based on enrichment and augmented information.

The augmented information sent to the OAM can be used to change the slice configuration, for example allocate more resources if SLA is predicted to not be fulfilled in a future time window.

Proposal 5: AI/ML for Predicting QoS and SLA Fulfilment should be Studied

2.3 AI/ML for Improved Radio Resource Management (RRM)

The use of AI/ML can provide an improved performance by leveraging new capabilities in learning complex interactions in the environment, one such environment with complex interactions is RRM. Potential RRM algorithms comprise, link-adaptation, rank-selection, power control, mobility decisions. The SI should investigate potential augmented information from UEs or gNBs in order to enable an even better RRM. The augmented information generated by an AI-model could for example comprise forecast values such as the predicted load in a future time frame for one RAN node, or a UE predicted future signal quality value.

As an example, the use case of link adaptation can be considered. Link adaptation is a function that needs to react to rather fast changes of radio conditions. A way to improve the performance of link adaptation would be to gain more granular information about the radio environment and to predict the optimal link adaptation configuration on the basis of a prediction of the radio conditions.

In order to enhance link adaptation performance the UE may provide higher granularity data to the serving RAN, such as more granular L1 measurements, measurements of UE speed, UL queuing delays.

At the same time the serving RAN may receive from neighbor nodes information about cross cell interference, e.g. in the form of number of UEs or resource utilization at cell edge, or indeed information either constituting or helping to extrapolate a prediction of cross cell interference.

With such information the serving RAN is able to derive a prediction of the channel condition for the UE and therefore to adopt a better link adaptation configuration.

Proposal 6: Investigate new AI/ML-based augmented information for improved RRM

VI.A. AI/ML Based Use Cases

1 Introduction

A new SI has been approved in RP-201620: “Enhancement for data collection for NR and ENDO”. As specified in the SID, the study is tasked to address the following objective:
a) Study standardization impacts for the identified use cases including: the data that may be needed by an AI function as input and data that may be produced by an AI function as output, which is interpretable for multi-vendor support.
b) Study standardization impacts on the node or function in current NG-RAN architecture to receive/provide the input/output data.
c) Study standardization impacts on the network interface(s) to convey the input/output data among network nodes or AI functions.

In R3-20xxxx a number of AI/ML use cases were described. The Use Cases could be classified as follows:
1. AI/ML for traffic steering, both comprising
   Capacity improvements
   Energy efficiency
2. AI/ML for QoS prediction
3. AI/ML for improved radio resource management (RRM)

This paper addresses the potential Standardization Impact of the Use Cases analyzed.

2 Standardization Impacts on a Per Use Case Class

2.1 Standardisation Impacts of AI/ML for Traffic Steering—for Capacity and Energy Efficiency

This class of Use Cases relies on the ability of the RAN to predict the best cell that will serve the UE. The Use Cases can include mobility scenarios triggered by various reasons (e.g. Energy Efficiency, radio conditions, load conditions) or multi connectivity scenarios (e.g. prediction of best PSCell). In general the use cases provide augmented information about the cell that, given the predicted conditions, will best serve the UE within a future time window.

In this class of Use Cases the main standardization impacts are foreseen to be on the following:
Uu Impact:
   Flow of information over Uu from UE to target RAN to derive performance characteristics for the UE after the mobility process
   Flow of information from UE to source RAN to derive prediction of conditions while at the source
Xn Impact:
   Signaling from target RAN to source RAN of information relative to the conditions and performance of the UEs after the mobility process took place.
   Signaling from target to source RAN of prediction information allowing to derive potential target cell status, e.g. load predictions per cell

Conclusion 1: The Use Case family of “AI/ML for traffic steering” may generate the following impacts:
Uu Impact:
   Flow of information over Uu from UE to target RAN to derive performance characteristics for the UE after the mobility process
   Flow of information from UE to source RAN to derive prediction of conditions while at the source
Xn Impact:
   Signaling from target RAN to source RAN of information relative to the conditions and performance of the UEs after the mobility process took place.
   Signaling from target to source RAN of prediction information allowing to derive potential target cell status, e.g. load predictions per cell

2.2 Standardisation Impacts of AI/ML for QoS Prediction

This class of Use Cases relies on the interaction between the RAN and the OAM system. In this class of Use Cases the RAN provides augmented information to the OAM concerning predictions of QoS levels.

Such QoS level predictions may consist of predictions of one or more QoS parameters forming the QoS profile of each bearer at a UE. While it might be considered that predictions could be derived on a per UE per bearer basis, it appears that the amount of information and predictions generated in this case may be overwhelming, as well as the computational effort to derive such number of predications. Instead, an equally effective approach with a lower burden on processing and storage could be that of deriving QoS predictions on a per QoS class basis. For example, QoS prediction could be derived on a per slice and per 5QI granularity.

In this class of Use Cases the main standardization impacts are foreseen to be on the following:
F1-C Impacts:
   Signaling from gNB-DU to gNB-CU of augmented information for parameters that may take part in QoS prediction derivation, e.g. Predictions of over the air transmission delays, predictions of packet error rates etc.
RAN-OAM Interface Impact:
   Signaling of predicted QoS levels from RAN to OAM, e.g. per QoS class, per slice
   Based on the QoS level predictions, OAM is able to run predictions on SLA fulfilment. Depending on the SLA fulfilment, OAM signals new policies to RAN influencing how SLAs may be met in the future (e.g. new per slice RRM policies)

Conclusion 2: The Use Case family of “Standardization Impacts of AI/ML for QoS monitoring” may generate the following impacts:
F1-C Impacts:
   Signaling from gNB-DU to gNB-CU of augmented information for parameters that may take part in QoS prediction derivation, e.g. Predictions of over the air transmission delays, predictions of packet error rates etc.
RAN-OAM Interface Impact:
   Signaling of predicted QoS levels from RAN to OAM, e.g. per QoS class, per slice
   Based on the QoS level predictions, OAM is able to run predictions on SLA fulfilment. Depending on the SLA fulfilment, OAM signals new policies to RAN influencing how SLAs may be met in the future (e.g. new per slice RRM policies)

2.3 Standardisation Impacts of AI/ML for Improved Radio Resource Management

In this class of scenarios it is possible to group all scenarios based on AI/ML model hosting at the RAN, so to allow for optimization of RRM processes via a fast control loop. The output of the AI/ML models in this family are prediction parameters that can be used when applying radio resource management. An example of such input could be a prediction of link adaptation configurations.

The RAN has today a very rich set of information that allow for good configuration of radio resource policies. However, there are information currently missing at the RAN, especially concerning the “view” UEs have of the surrounding conditions.

In this class of Use Cases the main standardization impacts are foreseen to be on the following:
Uu Impact: Flow of information over Uu from UE to RAN
F1-C Impact: Signaling of information from gNB-CU to gNB-DU to provide inputs to AI/ML Models assisting with radio resource management policy optimisation
Xn Impact: Signaling between neighbor nodes of information regarding current or predicted radio conditions, that can serve as input to AI/ML models for prediction of radio resource management policies

Conclusion 3: The Use Case family of “AI/ML for improved radio resource management” may generate the following impacts:
Uu Impact: Flow of information over Uu from UE to RAN
F1-C Impact: Signaling of information from gNB-CU to gNB-DU to provide inputs to AI/ML Models assisting with radio resource management policy optimization
Xn Impact: Signaling between neighbor nodes of information regarding current or predicted radio conditions, that can serve as input to AI/ML models for prediction of radio resource management policies

1. A method performed by a wireless communication device for machine-learned optimization of wireless networks, the method comprising:
sending, to a network node, information that indicates one or more capabilities of the wireless communication device for reporting of predicted values that are predicted by the wireless communication device using one or more machine learning capabilities of the wireless communication device;
receiving, from the network node, a request, the request comprising: (a) a request to start reporting predicted values based on a machine learning model, (b) a request to start training the machine learning model for generating predicted values, or (c) both (a) and (b); and
performing one or more actions in response to receiving the request.

2. The method of claim 1, wherein performing the one or more actions comprises:
generating one or more reports comprising one or more predicted values based on the machine learning model; and
sending the one or more reports to the network node.

3. The method of claim 2, wherein performing the one or more actions further comprises training the machine learning model for generating the predicted values.

4. The method of claim 2, wherein the one or more reports further comprise information that indicates an accuracy or confidence level of the one or more predicted values.

5. The method of claim 2, wherein generating and sending the one or more reports is activated when a triggering criterion is satisfied.

6. The method of claim 5, wherein the triggering criterion is a required accuracy level for the one or more predicted values, a required confidence level for the one or more predicted values, a time-based triggering criterion or a prediction performance-based triggering criterion.

7-9. (canceled)

10. The method of claim 5, wherein the triggering criterion is based on:
availability of network capabilities at the network node;
subscription to one or more services at the network node;
configuration at the wireless communication device for:
(a) Guaranteed Flow Bit Rate, GFBR, for Upload and Download;
(b) Maximum Packet Loss Rate for Upload and Download;
(c) reporting of Quality of Experience, QoE, measurements for at least one application; or
(d) any two or more of (a)-(c);
detection of a change of Quality of Service, QoS, parameters associated with the wireless communication device;
the wireless communication device being served by a certain slice;
the wireless communication device being static;
the wireless communication device being located within a geographic area;
the wireless communication device having a specific Service Profile Identifier, SPID; or
a movement pattern of the wireless communication device.

11. The method of claim 1, wherein the request comprises a request to start reporting predicted values at a particular time(s) or during a particular time window(s).

12. The method of claim 1, wherein the predicted values comprise predicted Radio Resource Management, RRM, related values, predicted beam related values, predicted values for future traffic needs of the wireless communication device, or predicted measurement values for:
(a) one or more frequencies;
(b) traffic steering;
(c) serving cell selection;
(d) Quality of Service, QoS, prediction;
(e) Radio Resource Management, RRM; or
(f) any two or more of (a)-(e).

13-15. (canceled)

16. The method of claim 1, wherein the information that indicates one or more capabilities of the wireless communication device for reporting of predicted values further comprises a performance metric indicative of an accuracy of the wireless communication device for performance of the one or more capabilities.

17. The method of claim 1, wherein the information that indicates the one or more capabilities of the wireless communication device for reporting of predicted values comprises physical characteristic data for the wireless communication device descriptive of:
(a) battery power;
(b) available memory;
(c) computational capacity;
(d) sensor capabilities;
(e) parameters descriptive of a physical environment of the wireless communication device;
(f) acceleration or velocity of the wireless communication device;
(g) nearby network infrastructure; or
(h) any two or more of (a)-(g).

18. The method of claim 1, wherein, prior to sending the information that indicates the one or more capabilities, the method further comprising:
receiving a request from the network node for the one or more capabilities of the wireless communication device for reporting of predicted values; and
wherein sending the information that indicates the one or more capabilities of the wireless communication device for reporting of predicted values comprises sending the information that indicates the one or more capabilities of the wireless communication device for reporting of predicted values responsive to receiving the request from the network node for the one or more capabilities of the wireless communication device for reporting of predicted values.

19. The method of claim 18, wherein performing the one or more actions in response to receiving the request comprises activating one or more procedures that replace measurements with predicted values.

20. The method of claim 1, wherein performing the one or more actions comprises, after transitioning from a connected state to an inactive state and subsequently transitioning back to the connected state in association to a second network node, providing data resulting from performing the one or more actions to the second network node.

21. (canceled)

22. (canceled)

23. A wireless communication device for machine-learned optimization of wireless networks, comprising:
one or more transmitters;
one or more receivers; and
processing circuitry associated with the one or more transmitters and the one or more receivers, the processing circuitry configured to cause the wireless communication device to:
send, to a network node, information that indicates one or more capabilities of the wireless communication device for reporting of predicted values that are predicted by the wireless communication device using one or more machine learning capabilities of the wireless communication device;
receive, from the network node, a request, the request comprising: (a) a request to start reporting predicted values, (b) a request to start training a machine learning model for generating predicted values, or (c) both (a) and (b); and
perform one or more actions in response to receiving the request.

24. (canceled)

25. A method performed by a network node for machine-learned optimization of wireless networks, the method comprising:
receiving, from a plurality of wireless communication devices, information that indicates one or more capabilities of the plurality of wireless communication devices for reporting of predicted values;
either or both of:
determining one or more wireless communication devices from which to request reporting of predicted values from the plurality of wireless communication devices based on the received information;
determining one or more reports to request from one or more wireless communication devices from among the plurality of wireless communication devices based on the received information; and
sending, to the one or more wireless communication devices, one or more messages, the one or more messages comprising: (a) a request to start reporting predicted values, (b) a request to start training a machine learning model for generating predicted values, or (c) both (a) and (b).

26-46. (canceled)

47. The method of claim 25, wherein, prior to receiving the information that indicates the one or more capabilities of the plurality of wireless communication devices, the method comprises:
receiving, from a supervised node, data indicative of a request to configure the one or more wireless communication devices for reporting of the predicted values.

48. The method of claim 47, further comprising:
receiving one or more reports from the one or more wireless communication devices, the one or more reports comprising predicted values; and
sending the one or more reports from the one or more wireless communication devices to the supervised node.

49. The method of claim 47, wherein the network node comprises a gNB-Centralized Unit, CU, and the supervised node comprises a gNB-Distributed Unit, DU.

50. (canceled)

51. (canceled)

52. A network node for machine-learned optimization of wireless networks comprising:
one or more transmitters;
one or more receivers; and
processing circuitry configured to cause the network node to:
receive, from a plurality of wireless communication devices, information that indicates one or more capabilities of the plurality of wireless communication devices for reporting of predicted values;
either or both of:
determine one or more wireless communication devices from which to request reporting of predicted values from the plurality of wireless communication devices based on the received information;
determining one or more reports to request from one or more wireless communication devices from among the plurality of wireless communication devices based on the received information; and
send, to the one or more wireless communication devices, one or more messages, the one or more messages comprising: (a) a request to start reporting predicted values, (b) a request to start training a machine learning model for generating predicted values, or (c) both (a) and (b).

53-57. (canceled)
